(19) United States
(12) Patent Application Publication
(10) Pub. No.: US 2016/0187295 A1
(43) Pub. Date: Jun. 30, 2016

(54) SEMICONDUCTOR MICRO-ANALYSIS CHIP AND METHOD OF MANUFACTURING THE SAME

(71) Applicant: KABUSHIKI KAISHA TOSHIBA, Tokyo (JP)

(72) Inventors: Kentaro KOBAYASHI, Tokyo (JP); Hideto FURUYAMA, Yokohama Kanagawa (JP)

(73) Assignee: KABUSHIKI KAISHA TOSHIBA, Tokyo (JP)

(21) Appl. No.: 15/060,506

(22) Filed: Mar. 3, 2016

Related U.S. Application Data
(63) Continuation of application No. PCT/JP2014/070145, filed on Jul. 24, 2014.

(30) Foreign Application Priority Data
Nov. 18, 2013 (JP) 2013-237768

(51) Int. Cl. G01N 27/447; B01L 3/00; G01N 15/10

(52) U.S. Cl. CPC G01N 27/44791; G01N 15/1031; G01N 27/44743; G01N 27/4473; B01L 3/502761; B01L 3/502715; B01L 3/502753; B01L 2200/0647; B01L 2200/0668; B01L 2400/0421; B01L 2300/0681; B01L 2300/069

(57) ABSTRACT

According to one embodiment, a semiconductor micro-analysis chip for detecting particles in a sample liquid includes a semiconductor substrate, a flow channel provided on a surface portion of the semiconductor substrate to allow the sample liquid to flow in the channel, and including a cap layer to cover at least an upper portion of the flow channel, a micropore provided at a part of the flow channel to allow the particles in the sample liquid to pass through the micropore, and a plurality of holes provided in the cap layer.

### CROSS REFERENCE TO RELATED APPLICATIONS

This application is a Continuation Application of PCT Application No. PCT/JP2014/070145, filed Jul. 24, 2014 and based upon and claiming the benefit of priority from Japanese Patent Application No. 2013-237768, filed Nov. 18, 2013, the entire contents of all of which are incorporated herein by reference.

### FIELD

Embodiments described herein relate generally to a semiconductor micro-analysis chip capable of detecting a particulate sample, and a method of manufacturing the same.

### BACKGROUND

Recently, in the technical fields of biotechnology, healthcare, and so on, micro-analysis chips having elements such as fine flow channels and detection systems integrated thereon have been used. These micro-analysis chips often have tunnel flow channels formed by providing covers over fine grooves formed on glass substrates or resin substrates. As a sensing method, counting fine particles using fine holes is known other than laser light scattering and fluorescent detection.

### BRIEF DESCRIPTION OF THE DRAWINGS

FIG. 1 is a plan view showing a schematic structure of a semiconductor micro-analysis chip according to a first embodiment;

FIG. 2 is a cross-sectional view showing a schematic structure of the semiconductor micro-analysis chip according to the first embodiment;

FIGS. 3A and 3B are enlarged views showing a part of a flow channel of a first semiconductor micro-analysis chip;

FIGS. 4A to 4D are cross-sectional views showing manufacturing steps of the semiconductor micro-analysis chip according to the first embodiment;

FIG. 5 is a plan view showing a schematic structure of a semiconductor micro-analysis chip according to a second embodiment;

FIG. 6 is an enlarged view of a part of a flow channel of the semiconductor micro-analysis chip of FIG. 5;

FIG. 7 is a plan view showing a schematic structure of a semiconductor micro-analysis chip according to a third embodiment;

FIG. 8 is a perspective view showing a schematic structure of the semiconductor micro-analysis chip according to the third embodiment;

FIGS. 9A to 9G are cross-sectional views showing manufacturing steps of the semiconductor micro-analysis chip according to the third embodiment;

FIG. 10 is a plan view showing a schematic structure of a semiconductor micro-analysis chip according to a fourth embodiment;

FIG. 11 is a perspective view showing a schematic structure of the semiconductor micro-analysis chip according to the fourth embodiment;

FIG. 12 is a cross-sectional view showing a schematic structure of the semiconductor micro-analysis chip according to the fourth embodiment;

FIGS. 13A and 13B are cross-sectional views showing a flow channel structure when a sacrifice layer is over-etched;

FIG. 14 is a cross-sectional view showing a functional operation of the semiconductor micro-analysis chip according to the fourth embodiment;

FIGS. 15A and 15B are illustrations showing an example of arrangement of pillar arrays of the fourth embodiment;

FIG. 16 is a perspective view showing a schematic structure of a semiconductor micro-analysis chip according to a fifth embodiment;

FIGS. 17A to 17F are cross-sectional views showing manufacturing steps of the semiconductor micro-analysis chip according to the fifth embodiment;

FIG. 18 is a plan view showing a schematic structure of a semiconductor micro-analysis chip according to a sixth embodiment;

FIG. 19 is a perspective view showing a schematic structure of the semiconductor micro-analysis chip according to the sixth embodiment;

FIGS. 20A to 20C are cross-sectional views showing a schematic structure of the semiconductor micro-analysis chip according to the sixth embodiment;

FIG. 21 is a plan view showing a modified example of the sixth embodiment;

FIG. 22 is a perspective view showing the modified example of the sixth embodiment;

FIGS. 23A to 23D are illustrations showing examples of arrangement of pillar arrays of the sixth embodiment;

FIG. 24 is a cross-sectional view for explaining a fine particle detection mechanism of the sixth embodiment;

FIG. 25 is a perspective view showing a schematic structure of a semiconductor micro-analysis chip according to a seventh embodiment;

FIG. 26 is a perspective view showing a schematic structure of a semiconductor micro-analysis chip according to an eighth embodiment;

FIGS. 27A and 27B are cross-sectional views showing a schematic structure of the semiconductor micro-analysis chip according to the eighth embodiment;

FIG. 28 is a graph for explaining the eighth embodiment and shows a difference between an ashing rate of a first tier and that of a second tier;

FIG. 29 is a perspective view showing a schematic structure of a semiconductor micro-analysis chip according to a ninth embodiment;

FIG. 30 is a plan view showing a schematic structure of a semiconductor micro-analysis chip according to a tenth embodiment;

FIG. 31 is a plan view showing a schematic structure of a semiconductor micro-analysis chip according to an eleventh embodiment; and

FIG. 32 is a perspective view showing a schematic structure of a semiconductor micro-analysis chip according to the eleventh eighth embodiment.

### DETAILED DESCRIPTION

In general, according to one embodiment, a semiconductor micro-analysis chip for detecting particles in a sample liquid comprises: a semiconductor substrate; a flow channel provided on a surface portion of the semiconductor substrate which allows the sample liquid to flow therein, and at least an upper portion of which is being covered by a cap layer; a micropore provided at a part of the flow channel to allow the particles in the sample liquid to pass therethrough; and a plurality of holes provided in the cap layer.

Embodiments will be hereinafter described with reference to the accompanying drawings. Some specific materials and structures are exemplified below, but materials and structures having the same functions as those described can be employed similarly, and are not limited to those of the embodiments described below.

### First Embodiment

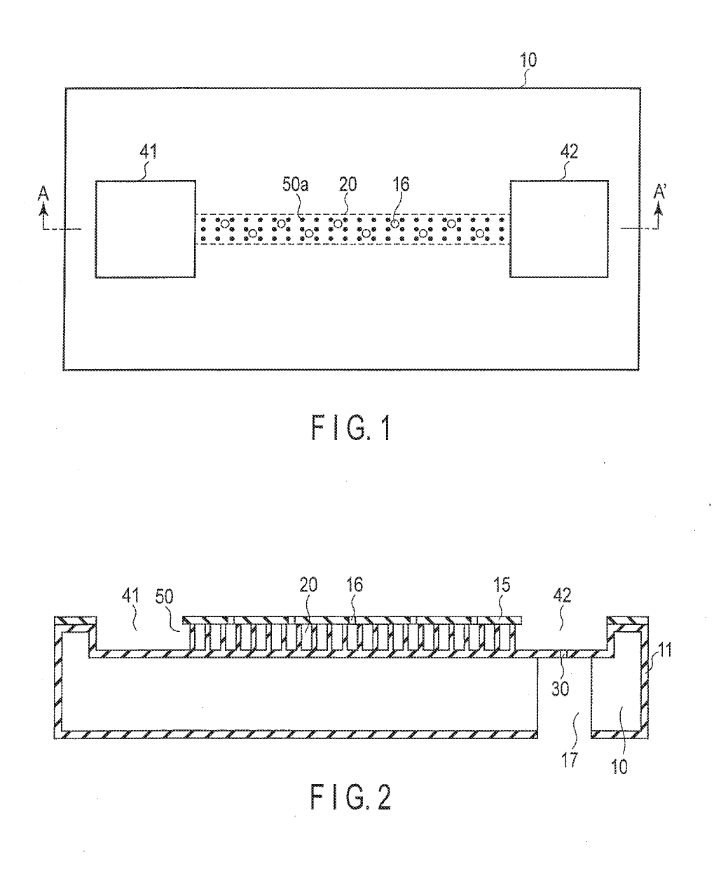

FIGS. 1 and 2 are figures describing a schematic structure of a semiconductor micro-analysis chip of a first embodiment. FIG. 1 is a plan view, and FIG. 2 is a cross-sectional view taken along line A-A′ of FIG. 1.

In the figures, reference number 10 denotes a semiconductor substrate. Various semiconductor materials, such as Si, Ge, SiC, GaAs, InP, and GaN, may be used for the substrate 10. In the following, an example of using Si for the semiconductor substrate 10 will be described.

On a surface portion of the Si substrate 10, a flow channel 20 is formed in a linear groove shape. The flow channel 20 is used to run a sample liquid including fine particles to be detected, and is formed by etching a surface of the Si substrate 10 with a size of, for example, 50 μm in width and 2 μm in depth. On both ends of the flow channel 20, an opening portion 41 and an opening portion 42 for introducing and discharging the sample liquid are provided, and electrodes can be inserted into the opening portions 41 and 42, respectively. At an area excluding the both ends of the flow channel 20, a pillar array 50 is provided. The pillar array 50 is constituted by columnar structures (pillars) 50a extending from the bottom of the flow channel 20 to the surface of the Si substrate, and the pillars 50a are arranged at regular intervals, as an array. A diameter of the pillar 50a is, for example, 1 μm, and a gap between adjacent pillars is, for example, 0.5 μm.

Here, the bottom of the flow channel 20 is covered by an SiO₂ film 11, and the pillar array 50 is also formed of SiO₂. Further, an upper portion of the flow channel 20 is covered by a cap layer 15 formed of SiO₂, and ashing holes 16 are formed at several places of the cap layer 15.

In the opening portion 42, an opening portion 17 is provided at the back side of the flow channel 20, and a micropore 30 is provided at the bottom of the flow channel 20. The flow channel 20 and the back opening 17 of the Si substrate 10 are spatially connected to each other via the micropore 30.

In the semiconductor micro-analysis chip of the present embodiment, when a sample liquid is poured into an introduction opening 41, that is, an inlet, the sample liquid flows through the flow channel 20 by the capillary action and then reaches a discharge opening 42, that is, an outlet. The back opening 17 is filled with an electrically conductive liquid which does not contain a particulate sample. Electrodes (metal wires, etc.) are inserted into the outlet 42 and the back opening 17, respectively, and a voltage is applied between these electrodes. These electrodes sense an ion current that flows between the electrodes via the micropore 30. When a particle passes through the micropore 30, the particle occupies a part of the micropore 30, and thus the electrical resistance of the portion of the micropore 30 changes. The ion current is changed in accordance with the change in the electrical resistance. As described above, a particle which has passed through the micropore 30 can be detected by observing the change in the ion current when the particle passes through the micropore 30.

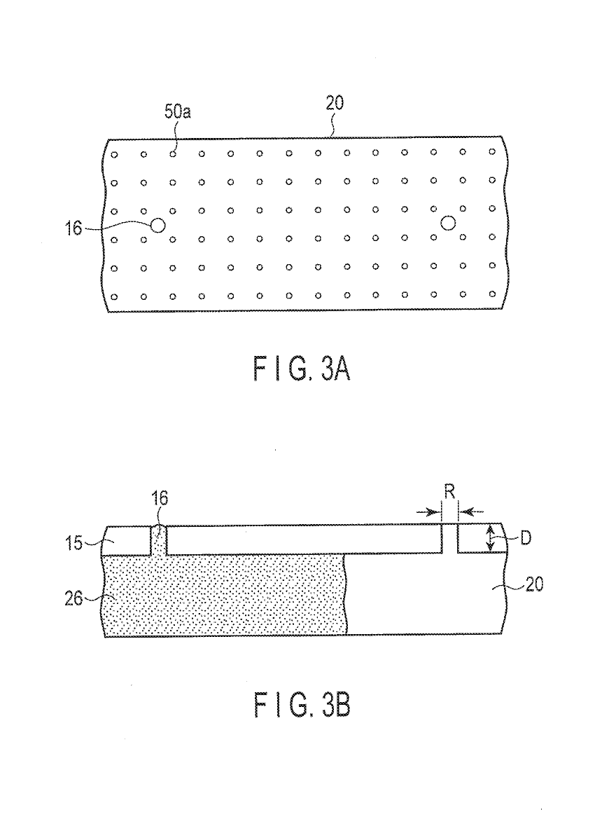

Here, if a diameter of each of the ashing holes 16 is too large, the sample liquid may flow out from the holes 16. Thus, a diameter R of each ashing hole 16 needs to be so small as the sample liquid would not flow out. FIG. 3A is a top view of a part of the flow channel 20, and FIG. 3B is a cross-sectional view of the flow channel 20 in a direction of the flow channel. As shown in FIG. 3B, when a sample liquid 26 flows through the flow channel 20, the liquid enters into the ashing hole 16. If the diameter of the ashing hole 16 is large, the sample liquid flows out of the flow channel 20 depending on the wettability of an inner wall of the ashing hole 16 and a top surface of the cap layer 15. On the contrary, if the diameter of the ashing hole 16 is small, for example, when diameter R of the ashing hole 16 is smaller than thickness D of the cap layer 15, a surface tension acts at the boundary between the ashing hole 16 and the top surface of the cap layer 15. Therefore, by making diameter R of the ashing hole 16 smaller than thickness D of the cap layer 15, the sample liquid 26 will not flow out of the flow channel 20 owing to the surface tension of the cap layer surface.

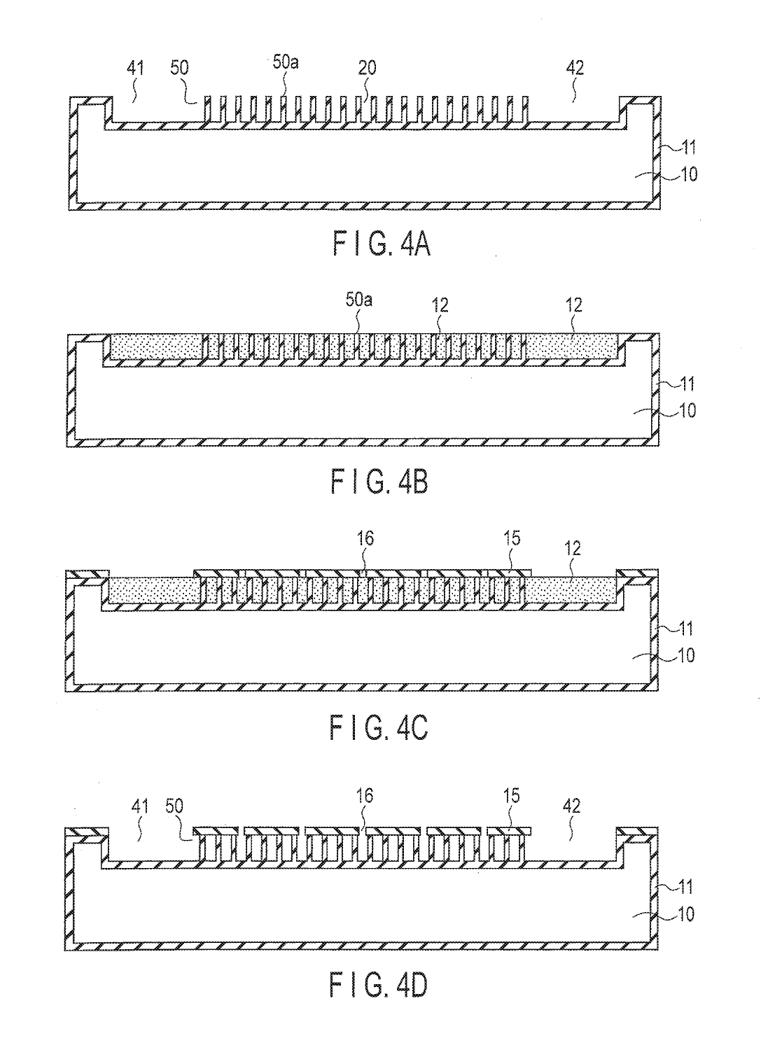

Next, a method of manufacturing the semiconductor micro-analysis chip of the present embodiment will be described with reference to FIGS. 4A to 4D.

Firstly, as shown in FIG. 4A, the inlet 41, the outlet 42, the flow channel 20, and the pillar array 50 are formed on the Si substrate 10. Here, a surface of the Si substrate 10 and the pillar array 50 are formed of a Si oxide film. In order to form these, the Si substrate 10 is selectively etched by RIE, etc., after forming a mask corresponding to the inlet 41, the outlet 42, the flow channel 20, and the pillar array 50 on the Si substrate 10. Oxidation process may subsequently be performed.

Next, as shown in FIG. 4B, a sacrifice layer 12 is filled into a flow channel portion to support forming a cap film on the flow channel. An organic material of polyimide resin, etc., is used for the sacrifice layer 12. For example, a precursor of polyimide resin is spin coated and thermally cured. After that, the cured part is planarized by chemical mechanical polishing (CMP), overall etching of polyimide resin, etc. Any material can be used for the sacrifice layer 12 as long as it can be selectively removed at a final stage, and allows an insulating film of SiO₂, SiNₓ, Al₂O₃, etc. to be stacked thereon. That is, the material of the sacrifice layer 12 is not limited to an organic material and may be another material.

Next, as shown in FIG. 4C, a cap layer 15 of SiO₂, etc., is formed on the surface of the Si substrate 10, covering over the sacrifice layer 12. Then, opening portions for the inlet 41 and the outlet 42 and ashing holes 16 are formed on the cap layer 15. Although the arrangement of the ashing holes 16 are not specifically restricted, it is better to have them arranged evenly to some extent in order to remove the sacrifice layer 12 with uniform ashing. If diameter R of the ashing hole 16 is larger than an interval between the pillars 50a, a part of the ashing hole 16 may overlap with the pillars 50a.

Next, as shown in FIG. 4D, the sacrifice layer 12 is selectively removed by oxygen plasma ashing, etc. At this time, ashing gas enters into the flow channel 20 through the ashing holes 16 as well as the inlet 41 and the outlet 42, resulting in speedily removal of the sacrifice layer 12. That is, by virtue of the ashing holes 16, the time required for the ashing process can be reduced and the sacrifice layer 12 can be removed uniformly.

Accordingly, in the present embodiment, fine particles can be detected only by introduction of the sample liquid and electrical observation. Further, ultraminiaturization and mass production can be implemented by the semiconductor processing technique, and a particle detection circuit, a particle discrimination circuit, etc., can also be integrated. Accordingly, ultraminiaturized and highly-sensitive semiconductor micro-analysis chips can be manufactured in large quantities and at low cost.

In addition, since the ashing holes 16 are formed in the cap layer 15 which covers the flow channel 20, removal of the sacrifice layer for flow channel formation can be conducted speedily and uniformly, then the time required for the ashing process can be reduced. Further, the ashing holes 16 can be made to serve as air holes when the sample liquid 26 is fed into the flow channel 20. Accordingly, the ashing holes 16 can prevent the air bubbles from being trapped in the flow channel 20 and make the flow of the sample liquid 26 smooth.

As described above, the semiconductor micro-analysis chip of the present embodiment is formed by integrating the flow channel 20 and a detection mechanism for fine particles on the semiconductor substrate. Fine particle detection is electrically carried out by filling the sample liquid 26 into the flow channel 20, and observing the ion current flowing through the micropore 30, which changes when the particle passes through the micropore 30.

The semiconductor micro-analysis chip as described above is made of a semiconductor wafer such as Si, and mass production technology with semiconductor fabrication process technology can be utilized. For this reason, the semiconductor micro-analysis chip can be minizaturized to a considerable degree and be manufactured in large quantities in comparison with a micro-analysis chip using a quartz substrate or a resin substrate that is often adopted in the prior art. Further, the semiconductor micro-analysis chips according to this embodiment do not require bonding process of bonding another substrate or a cover glass to form a sealing structure (lid) of the flow channel, and the cost of the bonding process can be cut down. Further, since the particles are to be detected electrically, noise elimination from detection signals by utilizing electronic circuit technology, and highly-sensitive detection with real-time digital processing (statistical processing, etc.) can be achieved. Moreover, a detection system can be made drastically compact in comparison with an optical detection system because the micro-analysis chip does not require equipment such as an optical system which occupies much space.

Also, in the semiconductor micro-analysis chip of the present embodiment, a plurality of holes are provided in the small flow channel, and these holes are used as the ashing holes for removing the sacrifice layer formed for forming the flow channel. The time required for removing the sacrifice layer can be thereby reduced drastically, and the manufacturing cost can be reduced.

### Second Embodiment

FIG. 5 is a plan view showing a schematic structure of a semiconductor micro-analysis chip of a second embodiment. Note that structural elements identical to those in FIG. 1 will be denoted by the same reference numbers as in FIG. 1, and detailed explanations of them will be omitted.

A difference between the present embodiment and the first embodiment described above is that a channel portion 25 which communicates with a flow channel 20 is provided on a side part of the flow channel 20, and an ashing hole 16 is formed in a cap layer 15 above the channel portion 25. For example, on both side surfaces of the flow channel 20, channels portions 25 which are slightly larger than ashing holes to be formed are arranged at regular intervals, and the ashing holes 16 are formed in each channel portion 25.

Even in this structure, because the ashing holes 16 are provided, removal of a sacrifice layer 12 in forming the flow channel 20 can be conducted speedily as in the above first embodiment. Further, the ashing holes 16 can be used as air holes for passing a sample liquid. Furthermore, in the present embodiment, holes are not directly formed in the flow channel 20, but the holes 16 are formed in the channel portions 25 provided at side walls of the flow channel. Accordingly, the present embodiment has an advantage of being able to form the holes 16 without decreasing the strength of a flow channel ceiling. Therefore, an advantage which is the same as that of the first embodiment can be obtained.

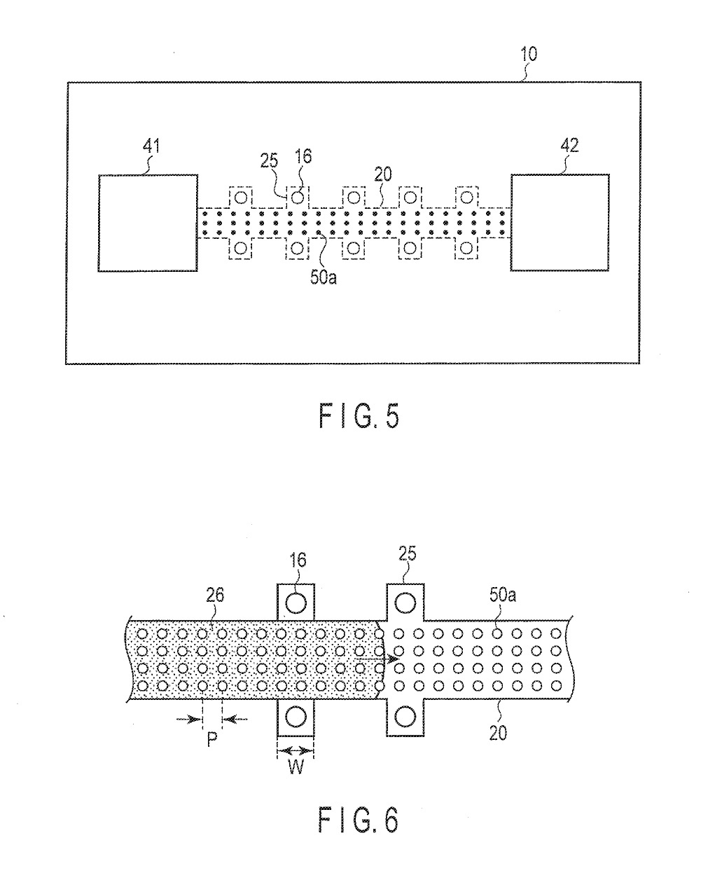

When a sample liquid 26 is made to flow through the flow channel 20, width W of the channel portion 25 should be made greater than pillar interval P, as shown in FIG. 6. Thereby, a capillary action between pillars 50a is greater than a capillary action in a direction of the channel portion 25 because of a surface tension at a boundary between a pillar array 50 and the channel portions 25, and the sample liquid 26 easily progresses in the direction of the flow channel (i.e., the direction indicated by an arrow in FIG. 6). Consequently, the sample liquid 26 does not intrude into the channel portions 25. Accordingly, the same rheological characteristics of the sample liquid as in the case of having no channel portion 25 can be obtained.

### Third to Eleventh Embodiments

Next, examples in which third to eleventh embodiments are applied to specific products will be described.

Each of semiconductor micro-analysis chips of the embodiments described below is formed by integrating small flow channels and a fine particle detection mechanism on a semiconductor substrate. A sample liquid (a suspension obtained by dispersing particles to be detected in an electrolyte) is introduced into a sample liquid inlet of a first flow channel, and the sample liquid or an electrolyte is introduced into a sample liquid inlet of a second flow channel, so that the flow channels are filled with their respective liquids. An ion current which flows through a micropore arranged between the first flow channel and the second flow channel varies when fine particles pass through the micropore, then the particles can be detected electrically by observing the ion current.

### Third Embodiment

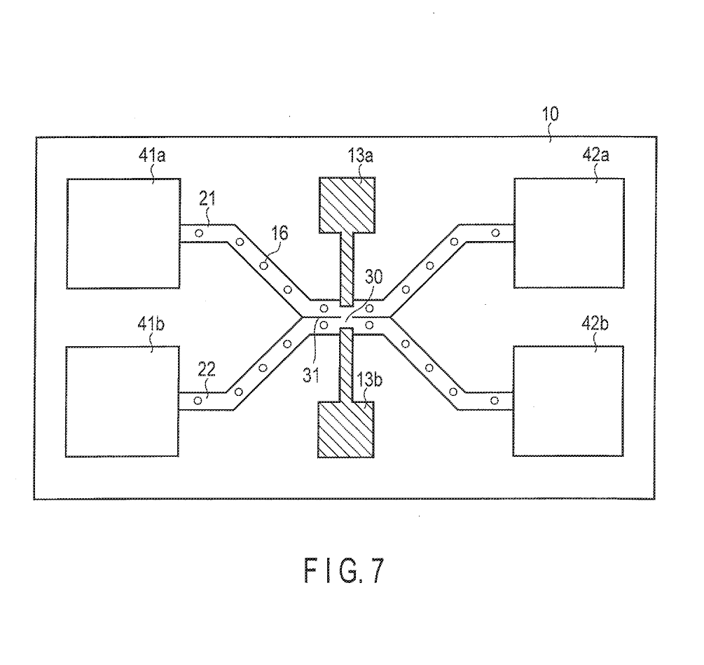

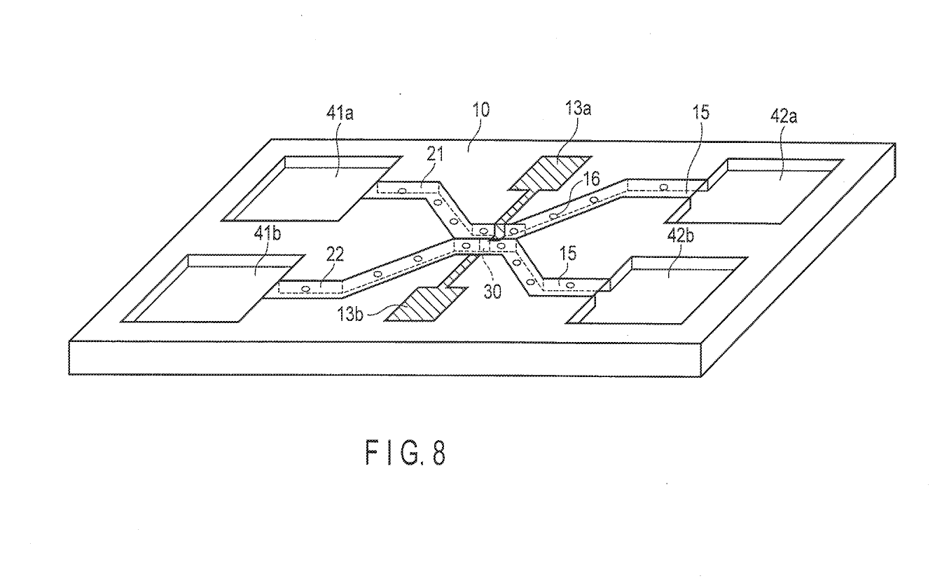

FIG. 7 is a top view schematically illustrating a semiconductor micro-analysis chip according to a third embodiment, and FIG. 8 is a perspective view for explaining a schematic structure of the semiconductor micro-analysis chip.

In the figures, reference number 10 denotes a semiconductor substrate. Various semiconductor materials, such as Si, Ge, SiC, GaAs, InP, and GaN, may be used for the substrate 10. In the following, an example in which Si is used for the semiconductor substrate 10 will be described.

Reference number 21 denotes a first flow channel in which a sample liquid flows, and 22 denotes a second flow channel in which the sample liquid or an electrolyte flows. The flow channels 21 and 22 are arranged to be partially close to each other in different layouts, and are formed by, for example, etching the Si substrate 10 to a width of 50 μm and a depth of 2 μm. An upper portion of each of the flow channels 21 and 22 is covered with an insulating thin film (having a thickness of, for example, 200 nm) such as a silicon oxide film (SiO₂), a silicon nitride film (SiNₓ), and an alumina film (Al₂O₃). As shown in FIG. 8, cap layers 15 are formed on the upper portions of the flow channels 21 and 22 as flow channel caps (i.e., lids to seal the flow channels 21 and 22). Both the first and the second flow channels are thereby formed as groove-shaped tunnel flow channels. As described later, ashing holes 16 to be used when removing a sacrifice layer are formed in the cap layers 15.

Reference numbers 41a and 42a denote an inlet and an outlet of the sample liquid located at the ends of the first flow channel 21, respectively. Reference numbers 41b and 42b denote an inlet and an outlet of the sample liquid or the electrolyte located at the ends of the second flow channel 22, respectively. The inlets and outlets denoted as 41a, 41b, 42a, and 42b are formed by etching a surface portion of the Si substrate 10 into a shape of a 1-mm-sided square, for example, with a depth of 2 μm, for example. The cap layers 15 are formed in the range of the flow channels 21 and 22, and no cap layer is formed in the inlets and outlets 41a, 41b, 42a, and 42b. The flow channels 21 and 22 are thereby formed as tunnel-like flow channels opening at their inlets and outlets.

Reference number 30 denotes a micropore provided at a contact portion between the first flow channel 21 and the second flow channel 22. The micropore 30 is formed by partial etching of a partition 31 (for example, an SiO₂ wall with a thickness of 0.2 μm) between the flow channel 21 and the flow channel 22 in a slit shape. The size (width) of the micropore 30 is not limited as long as it is slightly greater than the size of particles to be detected. When the size of the particles to be detected is 1 μm in diameter, the width of the micropore 30 of FIG. 7, may be, for example, 1.5 μm.

Reference numbers 13a and 13b denote electrodes configured to detect the particles. The electrodes 13a and 13b are formed to be partially exposed inside the flow channels 21 and 22, respectively. As the materials of the electrodes 13a and 13b, AgCl, Pt, Au, etc., may be used in the portion of surfaces where the electrodes are in contact with the sample liquid. The electrodes 13a and 13b do not necessarily have to be integrated as shown in FIG. 8. That is, even if the electrodes 13a and 13b are not integrated as shown in the present embodiment, the particles can be detected by attaching external electrodes to the inlets and outlets of the flow channels, respectively.

An ion current flowing through the micropore 30 is basically determined depending on the aperture size of the micropore 30. In other words, a static current caused by applying a voltage to the electrodes 13a and 13b in the flow channels 21 and 22, which are filled with the electrolytes, respectively, is determined depending on the aperture size of the micropore 30.

When a particle passes through the micropore 30, the particle partially blocks the passage of ions through the micropore 30, causing the ion current reduction in accordance with the degree of blockage. However, if the particle is conductive or can become conductive at a surface level, an ion current increase corresponding to the particle passage through the micropore 30 is observed because of electrical conduction of the particle itself caused by giving and receiving of ion charges. Such ion current variation is determined on the basis of the relative relationships in shape, size, length, etc., between the micropore 30 and the particles. For this reason, a feature of the particles passing through the micropore can be recognized by observing the amount of variation, transient variation, etc., of the ion current.

The aperture size of the micropore 30 may be determined by considering ease of passage of the particles to be detected and variation degree (sensitivity) of the ion current. For example, the aperture size of the micropore 30 may be 1.5 times to 5 times as great as the outside diameter of the particles to be detected. As the electrolyte to disperse the particles to be detected, a KCl solution or various buffer solutions such as a Tris Ethylene diamine tetra acetic acid (TE) buffer solution and a phosphate buffered saline (PBS) buffer solution may be used.

In the semiconductor micro-analysis chip of the present embodiment shown in FIGS. 7 and 8, the first flow channel 21 is used as a sample liquid introduction flow channel, and the sample liquid (i.e., a suspension liquid obtained by dispersing fine particles to be detected in an electrolyte) is dropped, for example, to the inlet 41a. At this time, since the flow channel 21 is the tunnel-like flow channel as described above, as soon as the sample liquid reaches the entrance of the flow channel 21, the sample liquid is sucked into the flow channel by the capillary action, and then the interior of the flow channel 21 is filled with the sample liquid. Here, the ashing holes 16 serve as air holes which eliminate air in the flow channel, so the sample liquid filling in the flow channel can be carried out smoothly.

The second flow channel 22 is used as a flow channel for receiving the detected particles. An electrolyte which does not include the particles to be detected is dropped into the inlet 41b, and then the interior of the inlet 41b is filled with the electrolyte. In the above state, by applying a voltage between the electrode 13a and the electrode 13b, particles passing through the micropore 30 can be detected.

A polarity of the voltage applied between the electrodes 13a and 13b varies depending on the charge of the particles (bacteria, viruses, labeled particles, etc.) to be detected. For example, to detect negatively-charged particles, a negative voltage is applied to the electrode 13a, and a positive voltage to the electrode 13b. In this configuration, the particles move and pass through the micropore by the electric field in the solution, or the particles are electrophoresed, and then the ion current variation is observed according to above-mentioned mechanism.

The second flow channel 22 as well as the first flow channel 21 can be filled with the sample liquid. This condition can be employed particularly when the charge of the particles to be detected is unclear or when positively-charged particles and negatively-charged particles are mixed. Even when the charge of the particles to be detected is known, the detection may be executed by filling both the flow channels with the sample liquid. In this case, because two types of solutions, i.e., the sample liquid and the electrolyte, do not need to be prepared, an operation relevant to detection of the particles can be simplified. However, the inlets 41a and 41b (outlets 42a and 42b) of the flow channels need to be electrically separated from each other, i.e., the sample liquid in one of the inlets (outlets) needs to be separated from that in the other one.

Thus, in the semiconductor micro-analysis chip of the present embodiment, the particles can be detected only by the sample liquid introduction and the electrical observation. Further, the ultraminiaturization and mass production can be implemented by the semiconductor processing technique, and a particle detection circuit, a particle discrimination circuit, etc., can also be integrated. Accordingly, ultraminiaturized and highly-sensitive semiconductor micro-analysis chips can be manufactured in large quantities and at low cost.

Therefore, by using the semiconductor micro-analysis chips of the present embodiment, highly-sensitive detection of bacteria, viruses, etc., can be easily conducted. The semiconductor micro-analysis chips of the present embodiment can contribute to preventing epidemic diseases from spreading and maintaining food safety, by applying the semiconductor micro-analysis chips to a rapid test of infectious pathogens, food-poisoning-causing bacteria, etc. The semiconductor micro-analysis chips are suitable for use in situations where a large number of chips need to be provided at very low cost. For example, they may be suitably used as high-speed primary test kits for diseases which require emergency quarantine action such as new strains of influenza, simple home-administered food-poisoning tests, and the like.

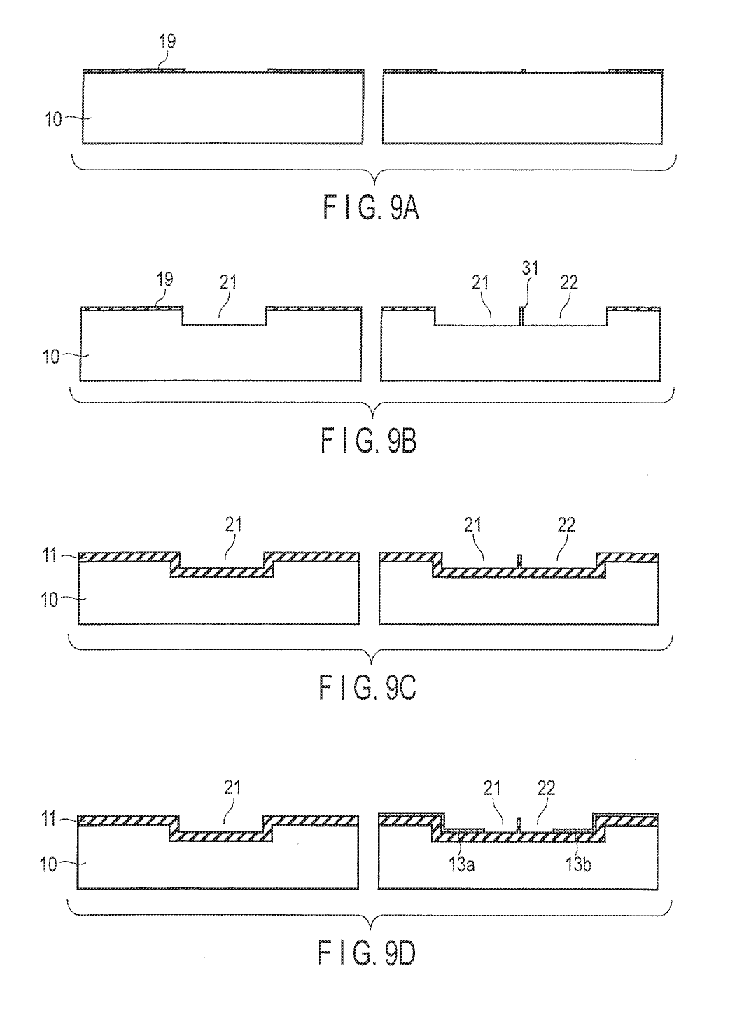

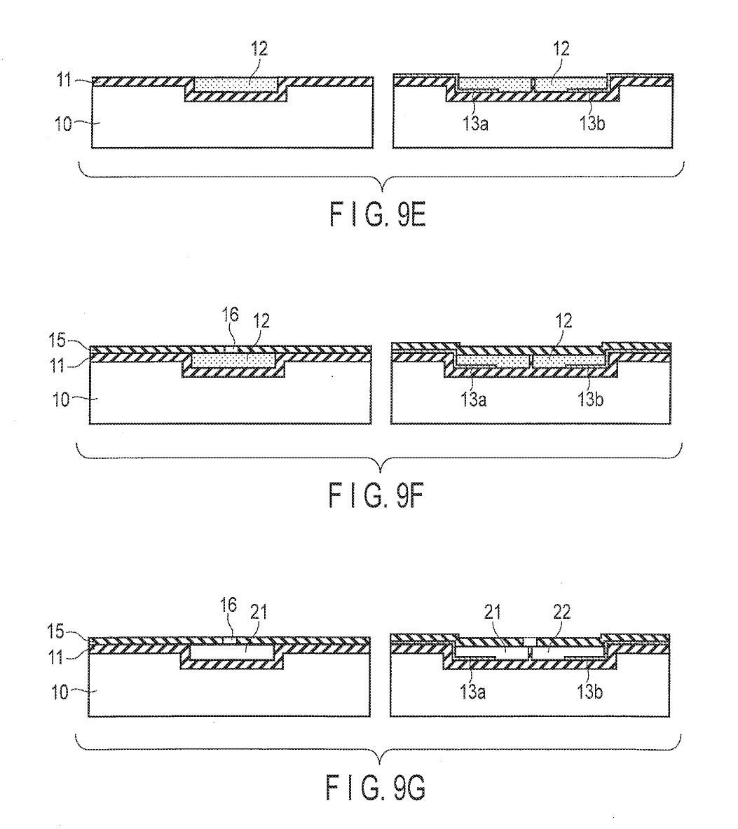

A method of manufacturing the semiconductor micro-analysis chip shown in FIGS. 7 and 8 will be hereinafter described with reference to FIGS. 9A to 9G. The steps of manufacturing the typical portions are illustrated in the cross-sectional views.

FIGS. 9A to 9G are cross-sectional views illustrating the manufacturing steps of the semiconductor micro-analysis chip of the present embodiment. Figures on the left side of FIGS. 9A to 9G are the cross-sectional views illustrating the first flow channel 21, and those on the right side are the cross-sectional views illustrating the contact portion of the first flow channel 21 and the second flow channel 22 as seen along a line intersecting the electrodes 13a and 13b.

In FIG. 9A, 10 denotes a silicon substrate, and 19 denotes an etching mask obtained by patterning a silicon oxide film (SiO₂). The SiO₂ film denoted as 19 is formed by chemical vapor deposition (CVD) to a thickness of 100 nm, for example. Then, the film is patterned by performing wet etching or dry etching using a resist mask (not shown) formed by photolithography. At this time, the aperture areas of the patterned etching mask 19 are the flow channels 21 and 22, the inlets 41a and 42a, the outlets 42a and 42b, and the slit-shaped micropore (which is located at a portion of an isolated pattern at the center in the right figure of FIG. 9A, or the portion 30 in FIG. 7). A width of the partition 31 which separates the first flow channel 21 and the second flow channel 22 from each other at the contact portion of the flow channels (i.e., the isolated pattern at the center in the right figure of FIG. 9A) is set at, for example, 100 nm.

Next, as shown in FIG. 9B, a surface of the silicon substrate 10 is etched with a depth of, for example, 2 μm, by using the etching mask 19. The etching of the substrate 10 is performed by deep reactive ion etching (RIE) such as the Bosch process so that the etched side surface is as perpendicular to the substrate 10 as possible.

Next, as shown in FIG. 9C, a thermally-oxidized silicon (SiO₂) film 11 is formed on the surface of the silicon substrate 10. At this time, the etching mask 19 may be removed prior to thermal oxidation or left in a state shown in FIG. 9B. The thermal oxidation is executed by, for example, using H₂O vapor to form the SiO₂ film to a thickness of, for example, 200 nm. At this time, since the 100-nm-thick partition 31 of the flow channels (i.e., the isolated pattern at the center in the right figure of FIG. 9C) is entirely oxidized from both side surfaces, the partition 31 is formed into an SiO₂ fence having a thickness of approximately 230 nm.

Next, as shown in FIG. 9D, the electrodes 13a and 13b are formed. The electrodes 13a and 13b may be formed by metal evaporation (resistive heating evaporation, electron beam heating evaporation, sputtering, etc.) on an image reverse resist pattern (not shown) and subsequent liftoff process. Alternatively, the electrodes may be formed by etching using the resist pattern, after performing full-surface metal evaporation. Electrode materials may be Ti/Pt, Ti/Pt/Au, Ti/Pt/AgCl, etc., and the materials of the surface in liquid contact are preferably AgCl, Pt, Au, etc.

Next, a sacrifice layer 12 to form caps of the flow channels is embedded in each of the flow channel portions as shown in FIG. 9E. An organic material of polyimide resin, etc. is used for the sacrifice layer 12. For example, a precursor of polyimide resin is spin coated and thermally cured. After that, a surface of the SiO₂ film 11 and portions of the electrodes 13a and 13b on the surface of the substrate are exposed by chemical mechanical polishing (CMP), overall etching of polyimide resin, etc. The material of the sacrifice layer 12 may be any as long as it can be selectively removed in a final stage, and allows subsequent formation of a layer of an insulating film of SiO₂, SiNₓ, Al₂O₃, etc. That is, the material of the sacrifice layer 12 is not limited to the organic material and may be other materials.

Next, as shown in FIG. 9F, an insulating film (SiO₂, SiNₓ, Al₂O₃, etc.) which constitutes the cap layers 15 are formed by the CVD or sputtering. The insulating film 15 is selectively etched after forming a resist pattern (not shown) having apertures at the inlets (outlets) 41a and 42a (41b and 42b), an electrode pad (external connection terminal) portion, and portions of the ashing holes. Here, the ashing holes 16 to be provided in the cap layers 15 are formed above the flow channel 21 and the flow channel 22 at an area excluding the contact portion of the flow channels 21 and 22.

Finally, as shown in FIG. 9G, the sacrifice layer 12 is selectively etched by oxygen plasma ashing, etc. The sacrifice layer 12 in each of the flow channels is removed via openings at the ends of the flow channels 21 and 22 and the ashing holes 16 by the oxygen plasma ashing. After removing the sacrifice layer, the flow channels 21 and 22 having the upper, lower, right and left sides surrounded by the insulating film are formed. At this time, because of the presence of the ashing holes 16, removal of the sacrifice layer can be conducted speedily and uniformly, and then it becomes possible to reduce the time required for the ashing process.

As can be seen, the semiconductor micro-analysis chip of the present embodiment can be manufactured in the general semiconductor device manufacturing process using the Si substrate. Further, not only can the particles be detected with high sensitivity by the semiconductor micro-analysis chip of the present embodiment, but also microfabrication of the semiconductor technology and mass production techniques can be applied thereto. For this reason, the semiconductor micro-analysis chip can be greatly miniaturized and manufactured at low cost.

Also, it becomes unnecessary to bond another substrate or a cover glass to form a sealing structure (lid) of the flow channels. Thus, as well as reducing the cost of the bonding process, ultra-compact chips and highly-sensitive detection can be achieved by introducing a new structure, such as a three-dimensional arrangement of flow channels, which had been difficult with the conventional technology. Further, since the particles are to be detected electrically, noise separation from detection signals by utilizing the electronic circuit technology, and highly-sensitive detection with real-time digital processing (statistical processing, etc.) can be achieved. Moreover, a detection system can be made extremely compact in comparison with an optical detection system because the micro-analysis chip does not require equipment such as an optical system which occupies much space.

Moreover, a plurality of holes are provided in the small flow channel, and these holes are used as the ashing holes for removing the sacrifice layer formed for forming the flow channel. By virtue of this feature, the time required for removing the sacrifice layer can be reduced drastically, and the cost of manufacturing can be reduced. Further, providing the ashing holes 16 can bring about an advantage of being able to avoid the risk of having air bubbles trapped in the flow channel 21, since the air in the flow channel 21 can be released from the ashing holes 16 when filling the sample liquid into the flow channel 21.

### Fourth Embodiment

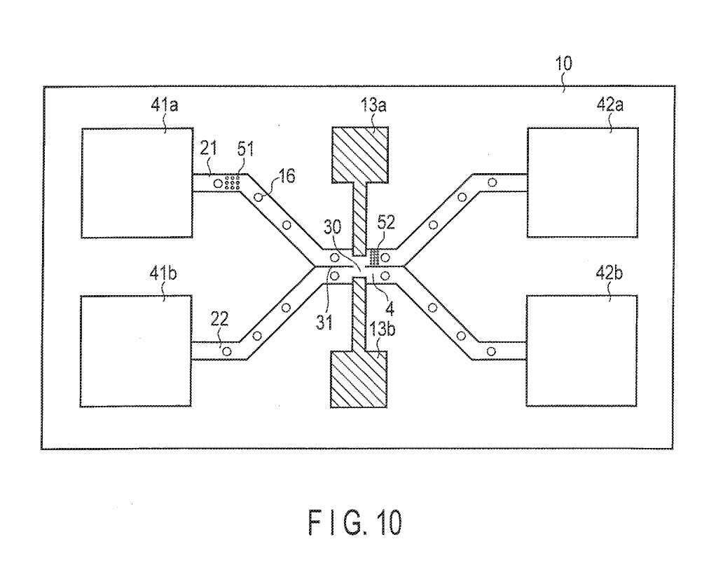

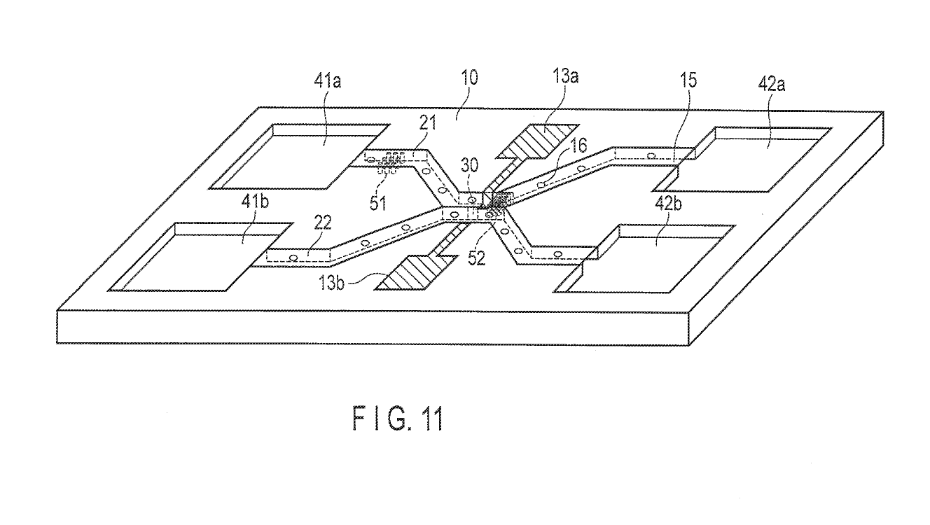

FIGS. 10 and 11 illustrate a schematic structure of a semiconductor micro-analysis chip of a fourth embodiment. FIG. 10 is a plan view of the semiconductor micro-analysis chip, and FIG. 11 is a perspective view of the same. In the present embodiment, a particle size filter is provided in a sample liquid flow channel 21.

In FIGS. 10 and 11, reference numbers 51 and 52 denote micro-size pillar arrays composed of micro-columnar structures (pillars) arranged at regular intervals to filter the particles in a sample liquid by size based on the intervals. Wall-like structure (slit) arrays, etc., can also be used instead of the pillar arrays 51 and 52. A structure and a function of the particle filter will be described taking the case of introducing the sample liquid to an inlet 41a and guiding the sample liquid to the flow channel 21 as an example.

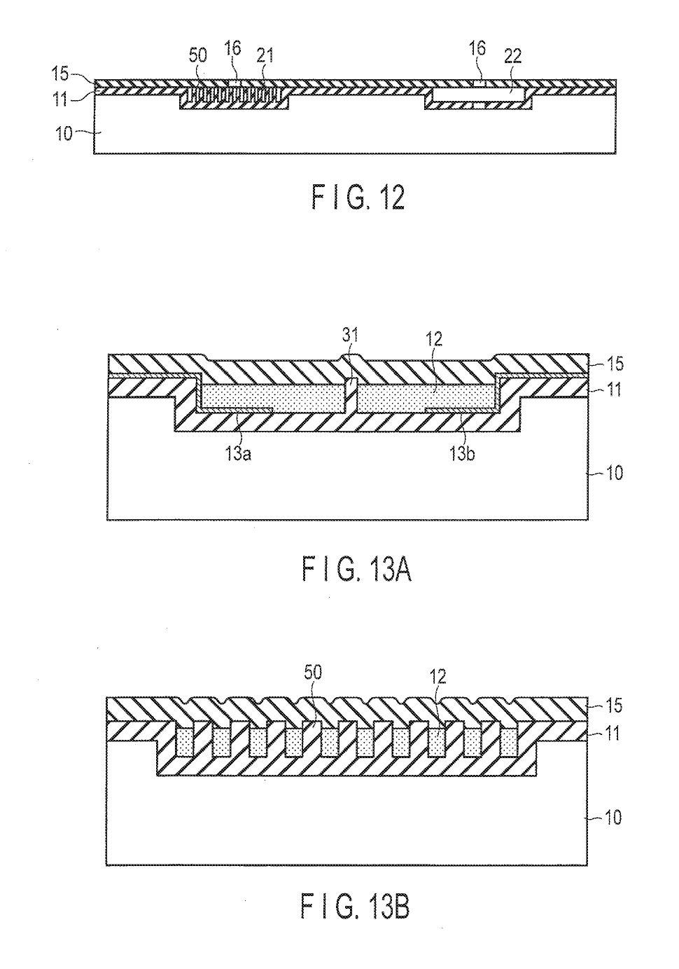

A pattern of the pillar arrays (or slit arrays) can be incorporated into an etching mask 19 at the process step of FIG. 9A described above, and can be formed by providing the mask 19 in the middle of the flow channel 21, at the same time as providing the isolated pattern 31 at the center in the right figure of FIG. 9A. Since the pillar arrays (or slit arrays) 51 and 52 are used to capture the particles in the flowing sample liquid, it is necessary to provide the pillar array such that no gap is formed between the pillar array and a side surface of the flow channel or a flow channel cap, as shown in FIG. 12. In particular, in order to make sure that no gap is formed between an upper portion of the pillar arrays and the flow channel cap, which cannot be controlled by the mask pattern, it is effective to preliminarily over-etch a surface of a sacrifice layer 12 slightly (by, for example, 0.2 μm) in the step of FIG. 9E.

FIG. 13A illustrates a cross-section of a substrate in a state in which an insulting film 15 is formed after over-etching the sacrifice layer 12 in the step of FIG. 9E. Since the sacrifice layer 12 is over-etched, a portion of a partition 31 protrudes in comparison with the sacrifice layer 12. A top surface of the insulating film (flow channel cap) 15 is therefore uneven at the portion of the partition 31. FIG. 13B illustrates the case in which the pillar array of FIG. 12 are formed. By etching the sacrifice layer 12 to expose the top of the pillar array, the top surface of the insulating film 15 is not flat, i.e., uneven above the flow channel 21 comprising the pillar arrays.

Thus, since the partition 31 or pillars 50 protrude in comparison with a top surface of the sacrifice layer 12, the flow channel cap can be formed with certainty on the partition 31 or the pillar arrays 51 and 52 without a gap, and then the flow channel cap and the partition 31 or the pillar arrays 51 and 52 are in close contact with each other. When an Si groove serves as the flow channel, forming the partition or pillars to have the above-described structure is very significant.

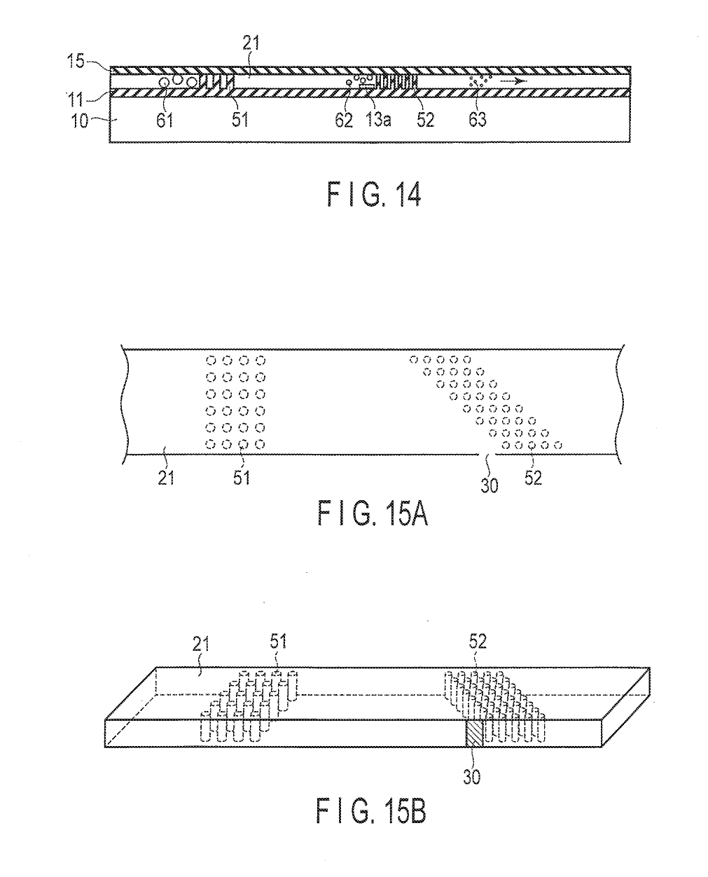

FIG. 14 schematically illustrates a function of the pillar arrays 51 and 52. The first pillar array 51 is provided at an upstream side of a micropore 30, and serves as a filter configured to remove large particles 61 which would clog the micropore 30. The pillar array 51 is formed such that pillars are provided at intervals which allow particles-to-be-detected 62 to pass through the pillar array 51 but do not allow the particles 61 having a diameter larger than the aperture of the micropore 30 to pass through. For example, if the size of the particle to be detected is 1 μmφ, and the diameter of the micropore is 1.5 μm, the pillars of the pillar array 51 are arranged in a manner described below. That is, as the pillar array 51, columnar structures having a diameter of 2 μm or quadrangular prism-shaped structures having a length of 2 μm on a side are arrayed so as to have an interval of, for example, 1.3 μm at maximum in a transverse direction of the flow channel. The number of steps (i.e., the number of rows) of the pillars of the pillar array 51 may be determined in consideration of trap efficiency of the large particles 61. Substantially almost all the particles having an outer diameter of 1.3 μm or more can be trapped when the pillar array 51 across the flow channel is arranged in the longitudinal direction of the flow channel with, for example, ten steps (ten rows) of pillars.

In addition, a multi-stepped filter structure can be provided such that a pillar array (not shown) having greater intervals of pillars is provided in the upstream of the pillar array 51 to preliminarily filter the particles having a size of, for example, 5 μmφ or more before the pillar array 51. In this case, it becomes easy to prevent the particle filter (pillar array 51) itself from being clogged by the large particles 61. For this reason, pretreatments such as centrifugation and preprocessing filtration of the sample liquid can be omitted, and thus the work for detecting the particles can be simplified and accelerated.

In FIG. 14, the pillar array 52 serves as a collector configured to collect and concentrate the particles-to-be-detected 62. The pillar array 52 is provided at a downstream side of the micropore 30, and pillars of the pillar array 52 are formed at intervals which do not allow the particles-to-be-detected 62 to pass through, but allow the electrolyte and microparticles 63 which have the size smaller than the size of the particles-to-be-detected 62 to pass through. For example, if the size of the particles to be detected is 1 μmφ, as the pillar array 52, columnar structures having a diameter of 1 μmφ or quadrangular prism-shaped structures having a length of 1 μm on a side are formed so as to have an interval of, for example, 0.9 μm at maximum in the transverse direction of the flow channel. The number of steps (i.e., the number of rows) of the pillars of the pillar array 52 may be determined in consideration of trap efficiency of the particles-to-be detected 62. Substantially almost all the particles having an outer diameter of 1.0 μm or more can be trapped by providing the pillar array 52 across the flow channel in the longitudinal direction of the flow channel 21 with, for example, ten steps (ten rows) of pillars.

In addition, as shown in FIGS. 15A and 15B, pillars of the pillar array 52 may be arranged so as to obliquely cross the flow channel 21, with the micropore 30 positioned close to a portion located at the most downstream side of the upstream side ends of the pillars. Since the trapped particles are guided to the portion of the micropore 30 efficiently, the detection efficiency can be enhanced.

Only one of the pillar arrays 51 and 52 may be provided instead of providing both of the pillar arrays. The number of the pillar arrays to be provided can be determined in consideration of the features of the sample liquid to be applied, process of the detection steps, etc. In addition to the pillar arrays 51 and 52 which serve as the particle size filters, pillar arrays with intervals greater than the intervals of the pillar arrays 51 and 52 may be formed all over the flow channel. In this case, each of the pillars can function as a supporting column of the cap of the flow channel, and can prevent the flow channel cap from being collapsed by an external pressure or a surface tension of the sample liquid. Moreover, the surface tension of the electrolyte can also act between the pillars to work as a driving force to suck the electrolyte, thereby enabling the flow channel to be filled with the sample liquid and the electrolyte more easily.

Here, in the case where the pillar arrays are arranged all over the flow channel as mentioned above, the sacrifice layer between the pillars needs to be removed in the sacrifice layer ashing step of FIG. 9G. In a conventional structure without the ashing holes 16, the sacrifice layer has to be removed from only the connection portions (flow channel openings) between the flow channels and the inlets and between the flow channels and the outlets. Accordingly, for the flow channel which has been substantially narrowed by the pillar arrays, the ashing efficiency is reduced and more time is required for ashing, and then the manufacturing cost is increased. In contrast, if the ashing holes 16 are provided as in the present embodiment, the sacrifice layer can be effectively removed via the ashing holes 16, and thus the process time can be shortened and sacrifice layer residues reduced.

Pillar arrays may also be formed at intervals greater than the pillar intervals which can be the particle size filter, in the regions of the sample liquid inlets 41a and 41b and the sample liquid outlets 42a and 42b. With the above configuration, the sample liquid and the electrolyte dropped onto the inlets can be spread by the surface tension of the pillar arrays, and the solutions can smoothly flow into the flow channels.

As can be seen, in the present embodiment, the particle size filtering function can be added by arranging the pillar arrays (or slit arrays) in the sample liquid inlet flow channel. Further, the detection steps can be simplified and the accuracy in detecting the particles can be enhanced by adding the functions of removing unnecessary particles, concentrating the particles to be detected, etc. Therefore, not only the advantage similar to the advantage of the third embodiment can be obtained, but the present embodiment also has the advantage that the detection time can be reduced and the detection errors can be reduced and prevented. Further, since the ashing holes 16 are provided, the sacrifice layer between the pillars can be effectively removed, allowing the manufacturing cost to be greatly reduced and the sacrifice layer residues reduced.

### Fifth Embodiment

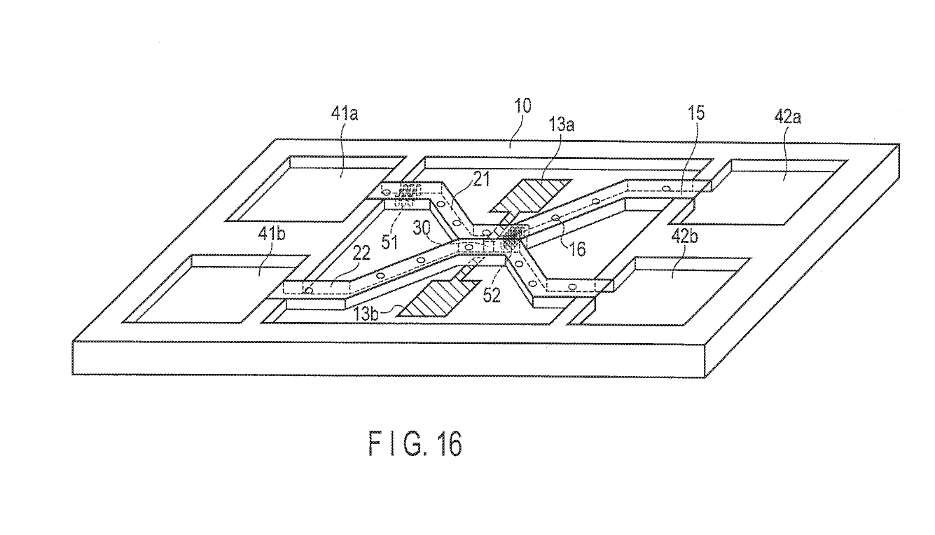

FIG. 16 is a perspective view showing a schematic structure of a semiconductor micro-analysis chip of a fifth embodiment. In this embodiment, flow channels 21 and 22 are not constituted by grooves of a Si substrate 10, but formed with tunnel-geometry insulating films.

In the embodiments shown in FIGS. 8 and 11, the steps of forming grooves of the flow channels 21 and 22 and selectively filling the grooves with the sacrifice layers 12 are necessary (FIG. 9E). In a method of etching back the entire surface of the sacrifice layer 12, however, the etching rate of the sacrifice layer varies greatly between the region where the grooves are formed and the region where they are not formed. For this reason, stopping the etching is difficult in the state shown in FIG. 9E. Also, etching failure such as a residue of the sacrifice layer outside the grooves, and excessive etching of the sacrifice layer in the grooves may easily occur due to variation in etching in the wafer surface. On the other hand, embedding the sacrifice layer in the grooves using CMP, the sacrifice layer residue may easily occur at stepped portions of the electrodes 13a and 13b. The above-mentioned situations often result in not only process failure such as peeling of films subsequently formed, but also leak failure of an ion current through a gap of the insulating films.

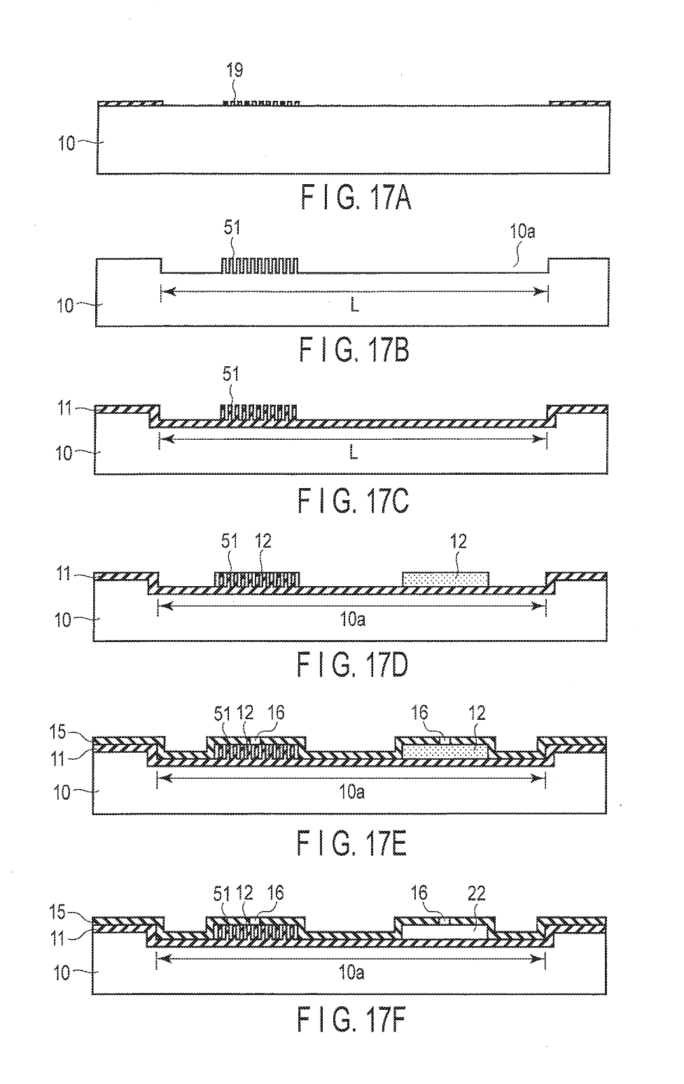

Accordingly, in the present embodiment, hollow structures with walls and ceilings formed of insulating films on the silicon substrate 10 are used as the flow channels instead of the grooves on the silicon substrate 10. In other words, by forming a sacrifice layer 12 in a flow channel pattern, covering a top surface and side surfaces of the sacrifice layer 12 by an insulating film, and removing the sacrifice layer 12, flow channels of a tunnel geometry insulting film are formed. FIGS. 17A to 17F show the manufacturing steps.

FIGS. 17A to 17F are cross-sectional views illustrating the manufacturing steps of the semiconductor micro-analysis chip of the present embodiment. In each figure, the left side illustrates a cross-section of a pillar array formation portion of a first flow channel 21, and the right side illustrates a cross-section of a second flow channel 22. A partition 31 at a contact portion of the flow channels 21 and 22 is formed similarly to that illustrated in the right views of FIGS. 9A to 9G, and a description thereof is omitted. In addition, since electrodes 13a and 13b are formed similarly as well, their descriptions are also omitted.

In FIG. 17A, reference number 10 denotes a silicon substrate, and 19 denotes an etching mask obtained by forming an SiO₂ film having a thickness of 100 nm by CVD, and patterning the film using photolithography.

As shown in FIG. 17B, a substrate-engraved-area 10a is formed by etching a surface of the silicon substrate 10 in a depth of, for example, 2 μm, by RIE using the etching mask 19 as a mask. At this time, apertures of the etching mask 19 correspond to regions for flow channels, reservoir portions (inlets and outlets), and a micropore, but the cross-sectional width of the region for flow channel is set to L, which is sufficiently greater than the width of the flow channels. The substrate-engraved-area 10a includes two flow channels, and side portions of each of the flow channels should be sufficiently wide. Also, pillar arrays 51 and 52 are formed in this step. By forming the pillar arrays 51 and 52 in regions wider than the flow channel width, creation of a gap caused by pattern deviation between the pillar arrays and the flow channels can be prevented.

Next, a thermally-oxidized SiO₂ film 11 is formed on the surface of the silicon substrate 10, as shown in FIG. 17C. At this time, the etching mask 19 may be removed before thermal oxidation or left as it is. The thermal oxidation is performed by, for example, using H₂O vapor, such that the SiO₂ film has a thickness of 200 nm. Also, the pillar arrays 51 and 52 are formed into SiO₂ completely by the thermal oxidation.

Next, the electrodes 13a and 13b (not shown) are formed, and the sacrifice layer 12 for forming flow channel walls and a ceiling is formed in a flow channel pattern, as shown in FIG. 17D. By using photosensitive polyimide resin as the sacrifice layer 12, the sacrifice layer pattern can be directly formed by applying, exposing, and developing the resin.

Next, an insulating film 15 (SiO₂, SiNₓ, Al₂O₂, etc.), which is to serve as the flow channel walls and caps, is formed to have a thickness of, for example, 500 nm, by CVD and sputtering, as shown in FIG. 17E. Then, apertures are formed in the insulating film 15 at the reservoir (inlet and outlet) portions and the electrode pad portions. Further, in portions located above the flow channels 21 and 22, a plurality of ashing holes 16 are formed in the insulating film 15.

Finally, the sacrifice layer 12 is selectively removed by oxygen plasma ashing and the like, as shown in FIG. 17F. The sacrifice layer 12 is ashed and removed from openings at the ends of the flow channels 21 and 22 and the ashing holes 16 by oxygen plasma. The flow channels 21 and 22 having their upper, lower, right and left sides surrounded by the insulating films are formed by removing the sacrifice layer 12.

Since the present embodiment does not involve etch-back process or CMP process of the sacrifice layer 12, in-plane unevenness such as residues of the sacrifice layer 12 and reduction of film thickness hardly occurs. Hence, process failure in the sacrifice layer formation steps is considerably reduced. Accordingly, not only the advantage similar to that of the third embodiment can be obtained, a manufacturing yield can also be improved. Further, by virtue of the ashing holes 16, the time required for the ashing process can be reduced and equalized. In addition, a gap between the thermally-oxidized film 11 and the cap layer 15 which would be caused by the residues of the sacrifice layer is essentially hard to be created. For this reason, a problem of leak failure of an ion current is also substantially resolved.

The inlets and outlets (41a, 41b, 42a, and 42b) of the present embodiment can be basically formed similarly to those shown in FIGS. 8 and 11, but liquid dams of the reservoirs need to be formed at portions of connection between the flow channels of the insulting film tunnel type and the reservoirs. For this reason, Si terraces may be formed beside the openings at the ends of the flow channels 21 and 22, as shown in FIG. 16. In addition, dummy flow channels may be formed at up to the Si terrace portions beside the openings at the ends of the flow channels, and used as the liquid dams.

### Sixth Embodiment

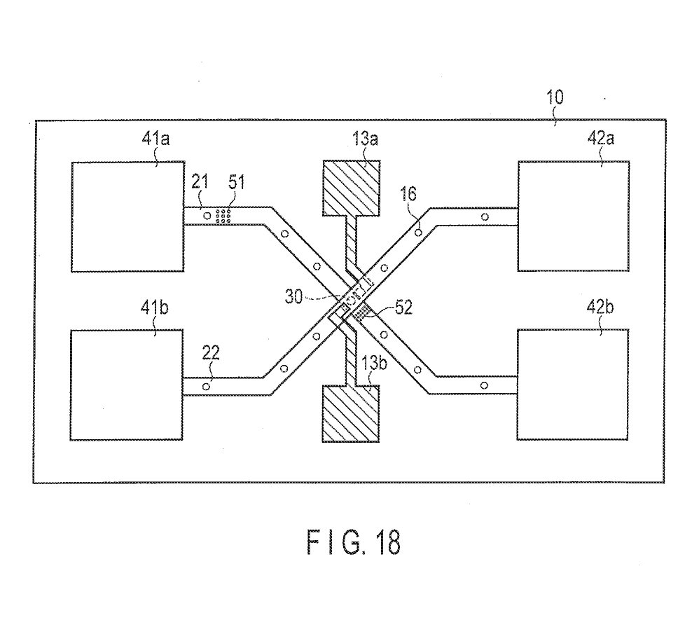

FIG. 18 is a plan view showing a schematic structure of a semiconductor micro-analysis chip according to a sixth embodiment. In this embodiment, a flow channel 21 and a flow channel 22 are formed in different steps, and a piled portion (contact portion) where the two flow channels intersect each other is provided. In this embodiment, two-tier flow channels in which the flow channel 21 serving as a sample supplying flow channel is formed at a lower tier, and the flow channel 22 serving as a sample receiving flow channel is formed at an upper tier are provided. Here, a micropore 30 is provided at the piled portion (contact portion) of the two flow channels. In other words, the micropore 30 is formed by photolithography at a partition (i.e., a cap layer 15 of the first flow channel 21) serving as an upper surface of the first flow channel 21 and a lower surface of the second flow channel 22.

In the embodiment shown in FIGS. 7 to 17, the micropore 30 needs to be formed at the partition perpendicular to the silicon substrate 10 since two flow channels are laterally adjacent to each other with the partition sandwiched between them. For this reason, the slit-like micropore 30 is formed by patterning in the direction perpendicular to that of the partition thickness. At this time, the shape of the micropore is a rectangle close to a square when a depth of the flow channels is the same as a width of the micropore. Alternatively, the micropore is a vertically long slit when the depth of the flow channels is greater than the width of the micropore. For this reason, when particles pass through the micropore 30, the aperture of the micropore 30 cannot be sufficiently shielded by the particles, and thus a variation in an ion current is small in comparison with a circular micropore.

In contrast, in the embodiment shown in FIG. 18, the micropore 30 can be directly patterned, and the aperture shape of the micropore can be arbitrarily determined. Thus, the micropore 30 can be designed to have a circular aperture by which the ion conduction can be most effectively shielded with the particles. At this time, the variation in the ion current associated with passing of the particles to be detected through the micropore 30 can be maximized, and the particles can be detected with much higher sensitivity than the detection in the embodiments shown in FIGS. 7 to 17.

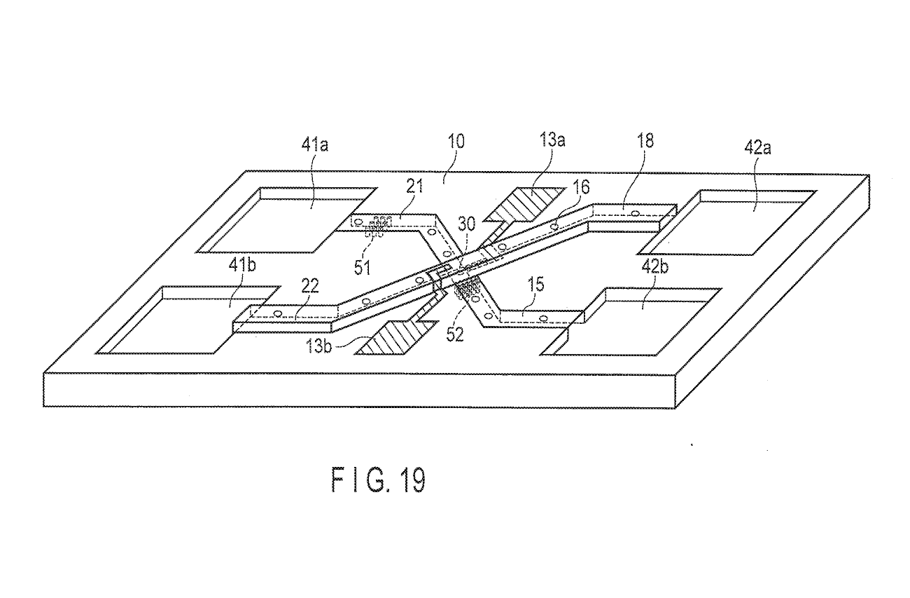

FIG. 19 illustrates a specific example of the two-tier flow channels. In this example, the first flow channel 21 is a tunnel flow channel obtained by engraving the Si substrate 10 similar to the flow channel shown in FIG. 8 while the second flow channel 22 is a flow channel of an insulting film tunnel type similar to the flow channel shown in FIG. 16. The first flow channel 21 is formed in the same manner as the steps shown in FIGS. 9A to 9G, and the second flow channel 22 is formed in the same manner as the steps shown in FIGS. 17A to 17F excluding the engraving step of the silicon substrate 10. However, formation of the first flow channel 21 is executed until the step shown in FIG. 9F. After that, the micropore 30 is formed at a flow channel contact portion of an insulating film 15.

Subsequently, the second flow channel 22 is formed in the steps shown in FIGS. 17D to 17F, and a sacrifice layer 12 of the first flow channel 21 and that of the second flow channel 22 are entirely removed simultaneously in the step shown in FIG. 17F. An electrode 13a is formed in the step shown in FIG. 9D, and an electrode 13b can be positioned on an upper surface of the second flow channel 22 if the electrode 13b is formed immediately after the step shown in FIG. 17D.

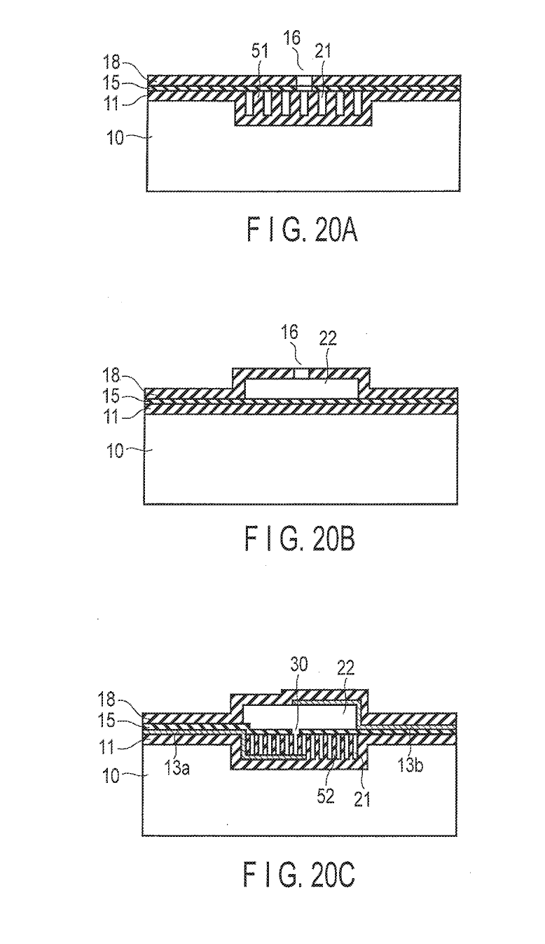

Consequently, the first flow channel 21 is a tunnel flow channel of an engraving type as shown in FIG. 20A, and the second flow channel 22 is a flow channel of an insulating film tunnel type, that is, a flow channel made of an insulating film (a cap layer) 18, as shown in FIG. 20B.

In addition, the micropore 30 is formed in the insulating film 15 at the contact portion where the two flow channels 21 and 22 intersect each other, as shown in FIG. 20C, and an aperture shape of the micropore can be determined arbitrarily. The electrodes for observing the ion current are formed on a lower surface of the first flow channel 21 and an upper surface of the second flow channel 22, respectively. High sensitivity can be thereby realized by optimizing the shape of the micropore while inheriting the advantages of the above-described embodiments. In addition, the present embodiment comprises the tunnel flow channel 21 of the Si engraving type, and the second flow channel 22 is formed on the insulating film 15. Therefore, the present embodiment also has an advantage that even if a gap is formed between an insulating film 11 and the insulating film 15 due to the residues of the sacrifice layer, no leak current occurs between the two flow channels.

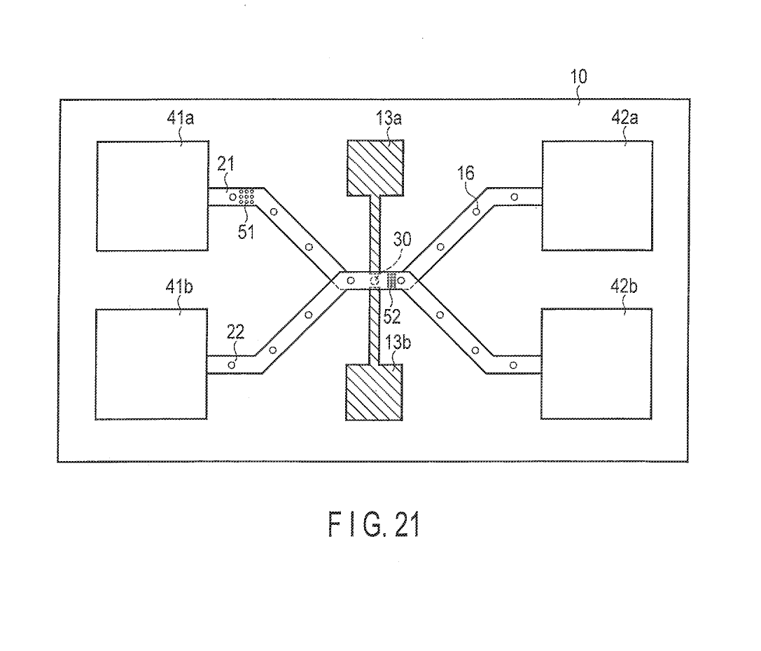

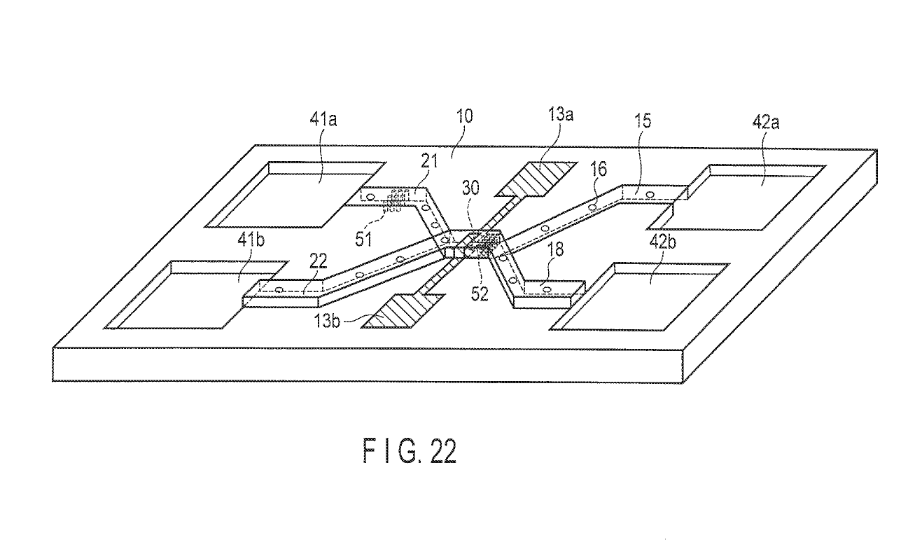

Since the two flow channels are arranged to intersect each other, a sample liquid introduced into an inlet 41a is to be discharged into an outlet 42b. However, the arrangement of the two flow channels is not limited to the intersection arrangement. For example, the two flow channels may be arranged as shown in the plan view of FIG. 21 or the perspective view of FIG. 22. In other words, the two flow channels may be arranged to be stacked and then to return to the respective corresponding flow channel sides (i.e., a sample liquid introduced into the inlet 41a may be discharged into the outlet 42a).

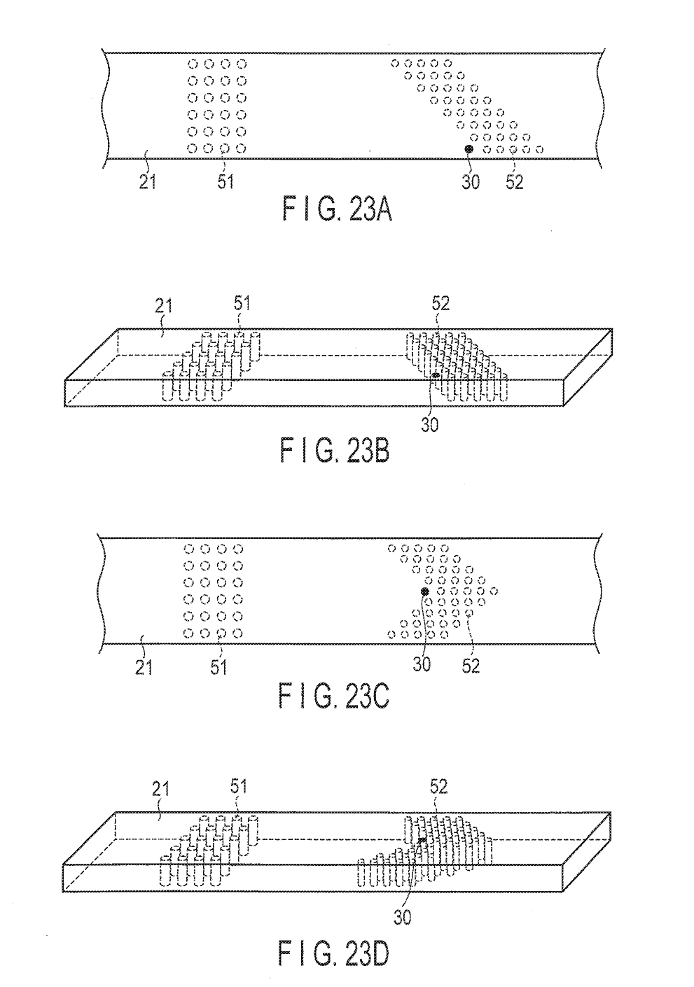

In FIGS. 23A and 23B, a pillar array 52 is arranged such that pillars of the pillar array 52 obliquely cross the flow channel 21, and the micropore 30 is positioned near a portion at the most downstream side of the pillar array 52 of the upstream side. FIG. 23A is a plan view, and FIG. 23B is a perspective view. Thus, detection efficiency can be enhanced since the particles trapped by the pillar array 52 are efficiently guided to the micropore 30.

Further, in FIGS. 23C and 23D, pillars of the pillar array 52 are arranged in a form of “>” with respect to the flow channel direction. FIG. 23C is a plan view, and FIG. 23D is a perspective view. The same advantage as that of the arrangement shown in FIGS. 23A and 23B can be obtained by arranging the pillar array as such. Considering that the micropore 30 is formed in a predetermined size, the micropore 30 is positioned at a central portion of the flow channel 21, when the pillars are arranged in the form of “>”. Accordingly, the arrangement in the form “>” shown in FIGS. 23C and 23D can be formed more easily than the oblique arrangement shown in FIGS. 23A and 23B.

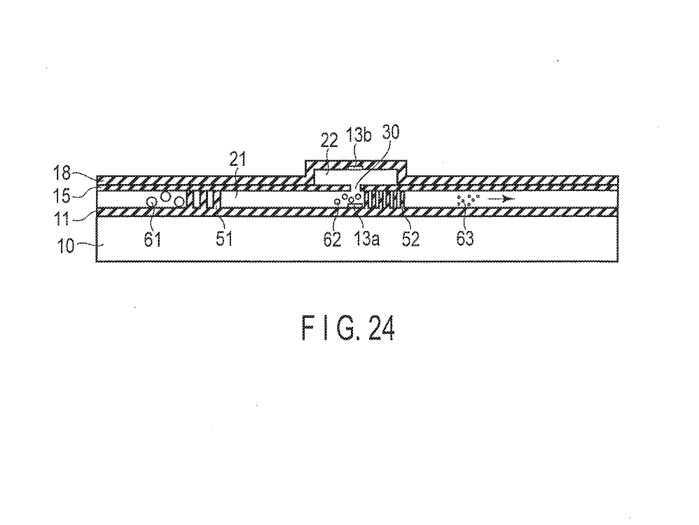

FIG. 24 schematically shows a particle detection mechanism of the present embodiment. A function of the pillar arrays 51 and 52 is the same as that as shown in FIG. 14. In FIG. 24, by applying a voltage between the electrodes 13a and 13b, particles 62 collected by the pillar array 52 are electrophoresed between the electrodes 13a and 13b, and moved to the side of the flow channel 22 through the micropore 30. At this time, since the ion current flowing between the electrodes 13a and 13b varies, and then the particles 62 can be detected.

According to the present embodiment, since the micropore 30 is formed to have the circular aperture by having the first flow channel 21 and the second flow channel 22 stacked, not only the same advantage as that of the third embodiment can be obtained, but also the particles can be detected with higher sensitivity.

### Seventh Embodiment

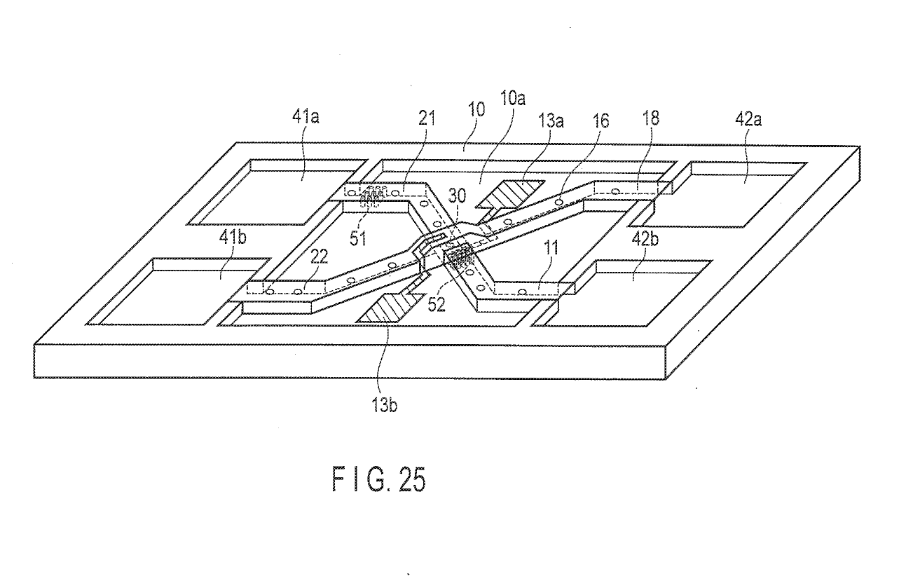

FIG. 25 is a perspective view showing a schematic structure of a semiconductor micro-analysis chip of a seventh embodiment. The present embodiment is a modified case in which a flow channel 21 and a flow channel 22 are formed in different steps, and a piled portion (contact portion) of the two flow channels is provided.

Both the first flow channel 21, which is a sample supplying flow channel, and the second flow channel 22, which is a sample receiving flow channel, are insulating film tunnel type flow channels. The two flow channels are formed in different steps, and a micropore 30 is formed by photolithography, at the piled portion of the two flow channels.

The present embodiment has a feature of solving inconvenience that filling the second flow channel with a sample liquid or an electrolyte sometimes cannot be successfully executed for the reason that the second flow channel 22 is different in height from a junction between the second flow channel 22 and the inlet/outlet (i.e., an opening portion) in the embodiment shown in FIG. 24. In the present embodiment, the first flow channel 21 of an insulating film tunnel type is formed in a flow channel portion 10a formed on a substrate, and the second flow channel 22 of an insulating film tunnel type is formed similarly after the first flow channel 21 has been formed. Thereby, the first flow channel 21 and the second flow channel 22 can be substantially the same height at their reservoir portions (an inlet 41a and an inlet 41b).

At the piled portion (i.e., the contact portion in FIG. 25) of the two channels, a space of the second flow channel 22 can be secured as shown in FIG. 24, because in the process of forming the second flow channel, a sacrifice layer for the second flow channel automatically climbs over the first flow channel 21. In the case of filling the first flow channel 21 and the second flow channel 22 with the sample liquid (or electrolyte), a problem that filling failure occurs at either of the flow channels can be thereby solved.

Thus, the present embodiment has an advantage of being able to prevent failure in filling the flow channels with the sample liquid or the electrolyte, in addition to the advantage of the sixth embodiment.

### Eighth Embodiment

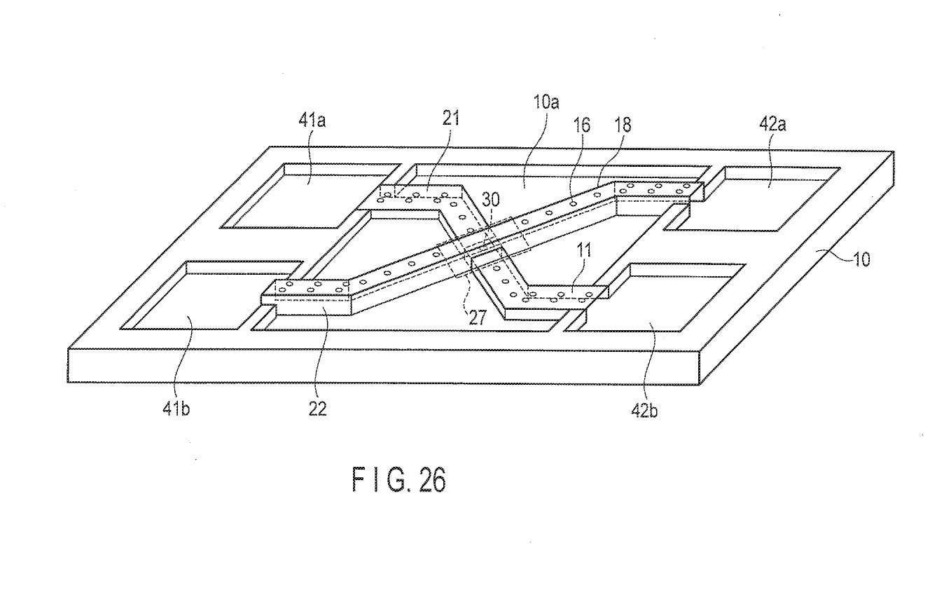

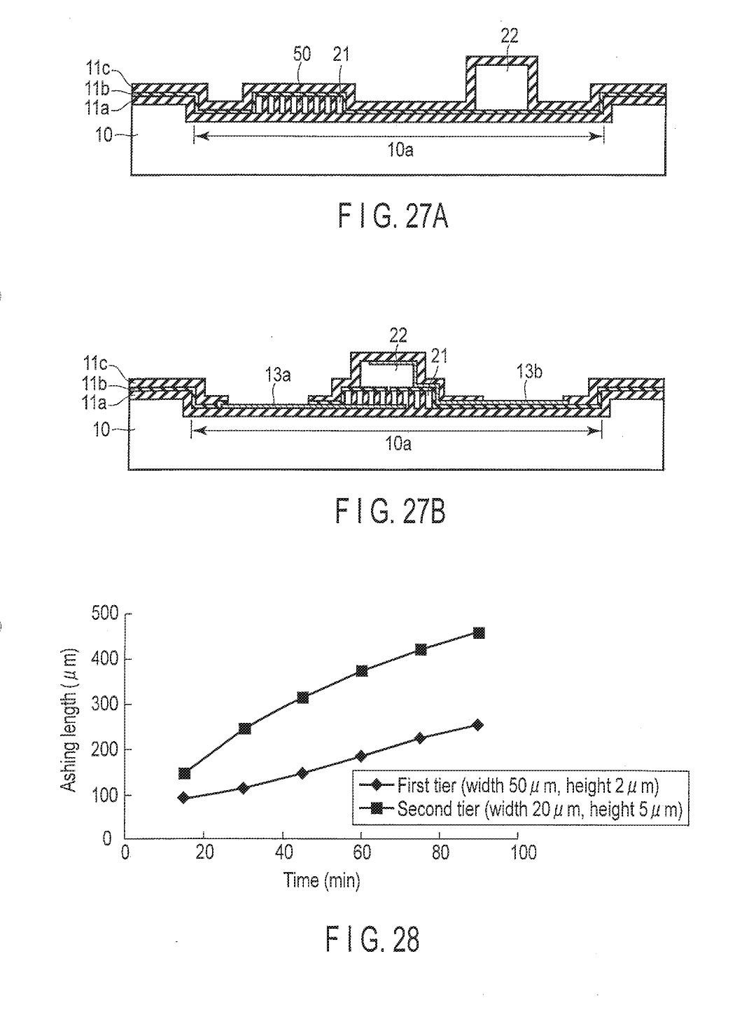

FIG. 26 is a perspective view showing a schematic structure of a semiconductor micro-analysis chip of an eighth embodiment. The present embodiment is a modified case in which a flow channel 21 and a flow channel 22 are formed in different steps, and a piled portion (contact portion) of the two channels is provided. FIG. 27A is a cross-sectional view of the flow channels, and FIG. 27B is a cross-sectional view of the contact portion of the flow channels.

Similarly to the embodiment shown in FIG. 25, both the first flow channel 21, which is a sample supplying flow channel, and the second flow channel 22, which is a sample receiving flow channel, are insulating film tunnel type flow channels. The two flow channels are formed in different steps, and a micropore 30 is formed by photolithography at the piled portion of the two flow channels. Further, the second flow channel 22 is formed to be higher than the first flow channel 21, as shown in FIGS. 27A and 27B.

Space above the first flow channel, which works as the second flow channel 22, can be secured with certainty at the piled portion (contact portion of FIG. 26) of the flow channels 21 and 22. Thus, a problem that the second flow channel 22 is collapsed at the piled portion of the flow channels 21 and 22, which may sometimes arise in the embodiment shown in FIG. 25, can be resolved. In the embodiment shown in FIG. 25, the second flow channel 22 is formed in the expectation that a second sacrifice layer would naturally climb over the first flow channel. However, because of product variations in the sacrifice layer materials and fluctuations of the temperature or moisture in the processing environment, it is difficult to form the flow channels with certain reproducibility. In the embodiment shown in FIG. 26, expecting an upper surface of the second flow channel to naturally climb over the first flow channel is not needed, because the flow channels which have different heights can be formed with certainty under different conditions for coating the sacrifice layer (i.e., a spin speed, etc.) or using the sacrifice layer materials of different viscosity.

At this time, it is desirable that the first flow channel 21 and the second flow channel 22 are formed to have the same cross-sectional area to equalize the amounts of sample liquid (or electrolyte) filled into the flow channels 21 and 22, which causes a substantially equal capillary action in the flow channels 21 and 22. For example, in the case where the first flow channel 21 has a width of 50 μm and a height of 2 μm, and the second flow channel has a width of 20 μm and a height of 5 μm, the flow channels 21 and 22 have the same cross-sectional area and 3 μm-height space between the first flow channel and the second flow channel can be secured at the piled portion.

The present embodiment therefore has an advantage of being able to solve the problem of the piled portion of the flow channels 21 and 22 being collapsed and to implement the micro-analysis chip of higher reliability, in addition to the advantage of the seventh embodiment.

In the case where stacked two-tier type flow channels are formed as in the present embodiment, if no ashing hole 16 is provided, an ashing rate of the first tier and that of the second tier greatly differ as indicated in FIG. 28. For this reason, ashing for removing the sacrifice layer takes too much time, and damage may be caused by unnecessary over-ashing in some places. In the present embodiment, since ashing holes 16 are provided, a difference in speed between the first tier and the second tier can be reduced. Accordingly, it becomes possible to reduce and equalize the time required for the step of forming the flow channels by removing the sacrifice layer.

Note that electrodes 13a and 13b are formed as in the embodiment of FIG. 25, although they are not illustrated in FIG. 26. Further, at a piled portion 27 where the flow channels 21 and 22 cross each other, ashing holes 16 are not formed since they may damage the electrode 13b. However, the ashing holes 16 may be formed away from the electrode 13b.

### Ninth Embodiment

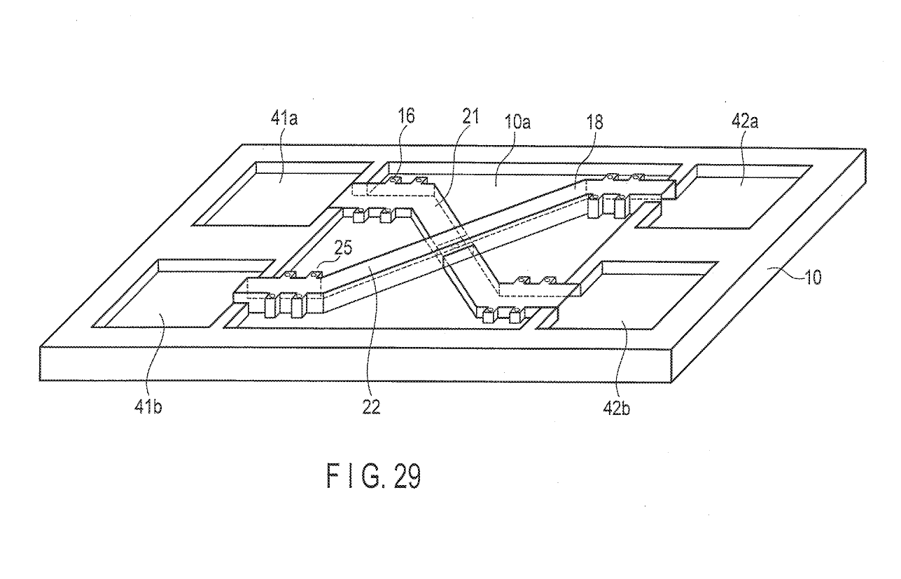

FIG. 29 is a perspective view showing a schematic structure of semiconductor micro-analysis chip of a ninth embodiment.

The basic structure of this embodiment is similar to that of the eighth embodiment previously described. A difference between the present embodiment and the eighth embodiment is that instead of providing ashing holes on flow channels, channel portions for forming ashing holes are provided on side walls of the flow channels and ashing holes are provided on these channels portions.

That is, at several portions of flow channels 21 and 22, channel portions 25 which are the same in height as the flow channels are provided on the side walls, and ashing holes 16 are formed on the upper surfaces of the channel portions 25. Further, pillar arrays which are not shown are formed in the flow channel 21.

With such a structure, in the process of removing a sacrifice layer for flow channel formation, oxygen plasma can be introduced into the flow channels 21 and 22 from ends of the flow channels 21 and 22 and the ashing holes 16 of the channel portions 25. Thereby, the sacrifice layer removal can be carried out speedily.

Thus, according to the present embodiment, an advantage similar to that of the eighth embodiment can be obtained. Also, since the holes 16 are formed in the channel portions 25 provided on the side walls of the flow channels 21 and 22, instead of forming the holes directly in channels 21 and 22, an advantage similar to that of the second embodiment previously described can be obtained.

### Tenth Embodiment

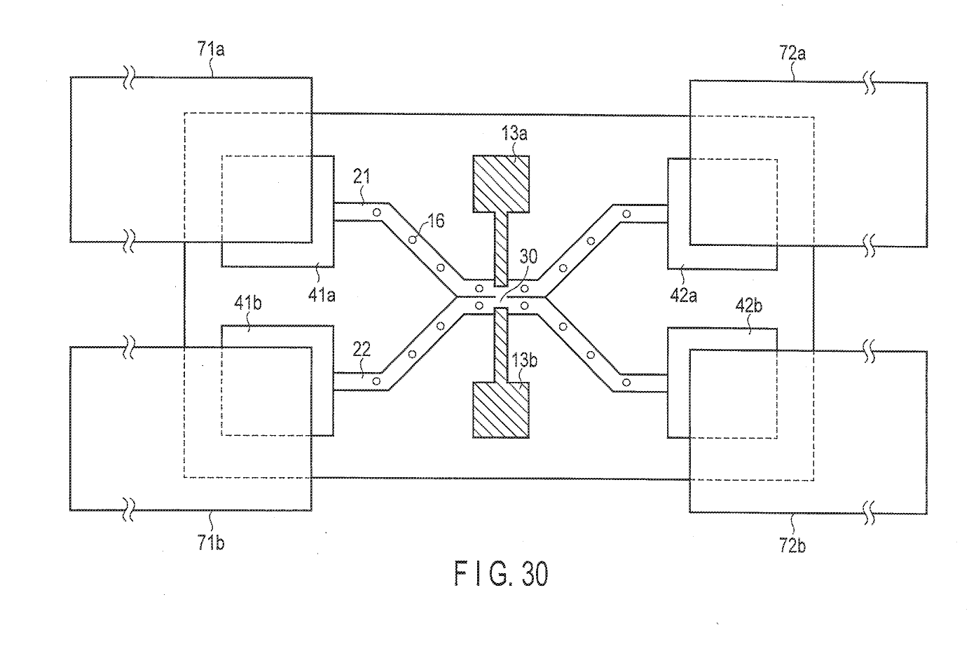

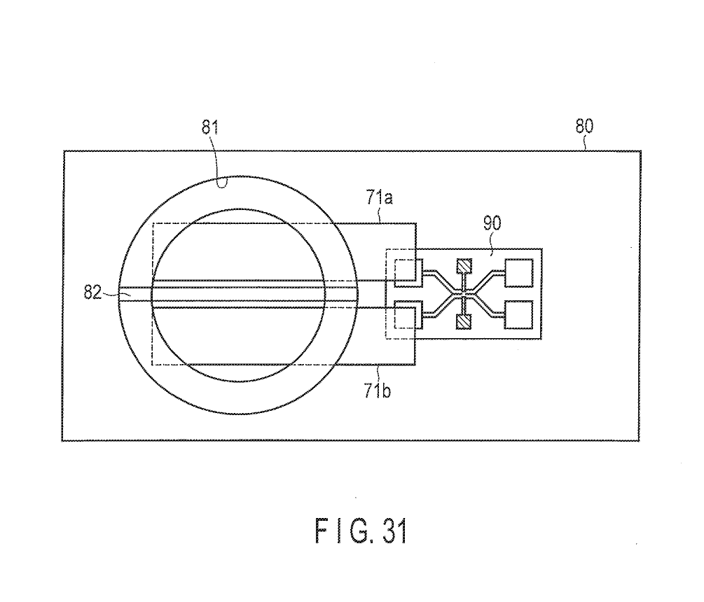

FIG. 30 is a plan view showing a schematic structure of a semiconductor micro-analysis chip of a tenth embodiment. In the present embodiment, a sample liquid is introduced into both a flow channel 21 and a flow channel 22, but an electrolyte may be introduced into either of the flow channels instead of the sample liquid.

An absorber 71a which can absorb the sample liquid is arranged on an inlet 41a, and an absorber 71b which can absorb the sample liquid or the electrolyte is arranged on an inlet 41b. Further, an absorber 72a which can absorb the sample liquid is arranged on an outlet 42a, and an absorber 72b which can absorb the sample liquid or the electrolyte is arranged on an outlet 42b. As the absorbers, filter paper and fiber assembly such as unwoven fabric can be used. Each of the absorbers may be arranged to cover all over a corresponding reservoir or arranged to partially cover the corresponding reservoir. However, the absorbers of adjacent reservoirs need to be separated from each other.

As described above in the third embodiment, the sample liquid is supplied to the inlet 41a and either one of the sample liquid and the electrolyte may be supplied to the inlet 41b. An example of supplying the sample liquid to the inlet 41b will be hereinafter described.

In this structure, the sample liquids including particles to be detected dropped on the absorbers 71a and 71b seep from the absorbers 71a and 71b and are guided into the inlets 41a and 41b. The sample liquids guided into the inlets 41a and 41b reach the outlets 42a and 42b through the flow channels 21 and 22, respectively. The sample liquids flowing through the flow channels 21 and 22 are absorbed into the absorbers 72a and 72b arranged on the outlets 42a and 42b. Once the absorbers 72a and 72b start absorbing the sample liquids in the outlets 42a and 42b, sample liquids flowing into the outlets 42a and 42b in succession are absorbed into the absorbers 72a and 72b. Thus, the sample liquids in the flow channels 21 and 22 flow continuously.

That is, by absorbing the sample liquids using the absorbers 72a and 72b, the sample liquids in the flow channels 21 and 22 can be made to flow without using electrophoresis or an external pump, and particles included in the sample liquids can be made to move in the flow of the sample liquids. For this reason, the absorbers 71a and 71b on the sides of the inlets 41a and 41b can be omitted.

In addition, a sufficient amount of sample liquid can be supplied to the flow channels 21 and 22 without increasing the size of the semiconductor micro-analysis chip, by arranging the absorbers 71a and 71b on the sample liquid inlet side. In general, introduction of the sample liquid into a micro-analysis chip is executed by using a micropipet, etc., and the amount of instillation of the sample liquid is approximately 10 to 10,000 μl. To contain this amount of sample liquid, for example, an area of approximately 100 mm² is required with a depth of 100 μm. Integrating such a large containing region, a semiconductor micro-analysis chip requires much larger area than that for integrating functional parts, which results in considerable increase of manufacturing cost. In addition, concentration of the particles in the sample liquid is generally low. If it is necessary to detect a number of fine particles, a large amount of sample liquid needs to be introduced into the chip, and thus the sample liquid containing region needs to be vast.

In the semiconductor micro-analysis chip of the present embodiment, sufficiently large absorbers 71a and 71b are provided outside the analysis chip, instead of integrating a very large sample liquid containing region. Then, the sample liquids are instilled into the absorbers 71a and 71b and introduced into the flow channels 21 and 22, respectively. The sample liquids discharged from a sample outlet side can be absorbed into the absorbers 72a and 72b. Thus, a larger amount of sample liquid than the amount of the sample liquid contained in the analysis chip can be introduced and discharged.

It is desirable that pillar arrays with intervals greater than those of the above-mentioned particle size filter be formed in regions of the inlets and outlets 41a, 41b, 42a, and 42b, and that the absorbers be arranged to contact the pillar arrays. In this way, delivery of the sample liquid or the electrolyte between the absorbers 71a, 71b, 72a and 72b and the corresponding inlets and outlets is smoothly executed by a surface tension of the pillar arrays. Further, the sample liquid or the electrolyte can easily and smoothly be introduced into the flow channel from the absorber.

Thus, according to the present embodiment, not only the advantage similar to that of the third embodiment can be obtained, but also the advantage described below can be obtained as a result of providing the absorbers 71a, 71b, 72a, and 72b on the inlets and outlets 41a, 41b, 42a, and 42b.

That is, the sample liquids in the flow channels 21 and 22 can be made to flow without using electrophoresis or an external pump, by providing the absorbers 72a and 72b on the sides of the sample liquid outlets 42a and 42b. Further, a sufficient amount of sample liquid can be supplied to the flow channels 21 and 22 without increasing the size of the semiconductor micro-analysis chip, by providing the absorbers 71a and 71b on the sides of the sample liquid inlets 41a and 41b. A large amount of sample liquid can therefore be handled by a very small analysis chip. In other words, cost can be considerably reduced by integrating functional parts of the semiconductor micro-analysis chip in a minimum area.

### Eleventh Embodiment

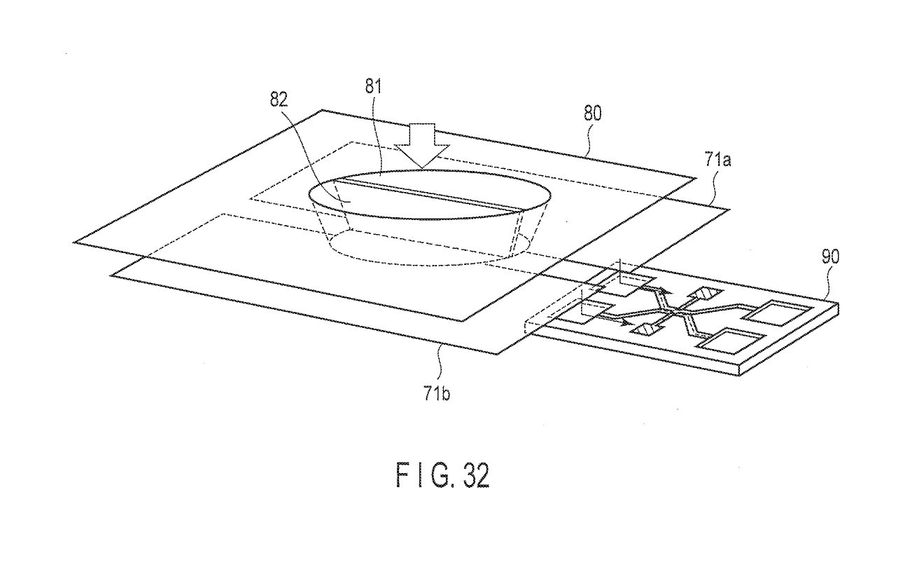

FIGS. 31 and 32 show a schematic structure of a semiconductor micro-analysis chip 90 of an eleventh embodiment. FIG. 31 is a plan view and FIG. 32 is a perspective view.

In the present embodiment, a sample liquid inlet port 81 is provided on a package 80 configured to contain the semiconductor micro-analysis chip shown in FIG. 29. The sample liquid inlet port 81 is formed by forming an aperture on a top surface located above absorbers 71a and 71b of the package 80, and providing a funnel-shaped solution guide configured to guide a sample liquid to the absorbers 71a and 71b. The sample liquid inlet port 81 is great enough to spread over both the absorbers 71a and 71b. A partition plate 82 configured to separate the sample liquid for the absorber 71a and the absorber 71b is provided in the sample liquid inlet port 81.

FIG. 32 does not illustrate absorbers 72a and 72b on a sample liquid outlet side, but of course, the absorbers 72a and 72b may be provided. In addition, the structure of the semiconductor micro-analysis chip 90 is not limited to the example shown in FIG. 31, but can be arbitrarily modified similarly to the above-described embodiments.

In this structure, the sample liquid can be absorbed into the absorbers 71a and 71b with certain separation, only by dripping the sample liquid onto a central portion of the sample liquid inlet port 81. Then, the sample liquid can be guided to inlets 41a and 41b corresponding to the absorbers 71a and 71b, respectively, and can be made to further flow into flow channels 21 and 22. Therefore, the sample liquid does not need to be introduced to the inlets 41a and 41b individually, and can be guided by a simple operation. In addition, the size of the micro-analysis chip, in particular, the size of the reservoir portions can be minimized enough to overlap the absorbers, and the micro-analysis chip can be ultra-miniaturized. As a result, the cost of the micro-analysis chip can be reduced.

### Modified Embodiments

The semiconductor micro-analysis chip is not limited to the above-described embodiments.

The Si substrate is mainly used in the embodiments. However, the material of the substrate is not limited to Si, and other semiconductor substrate materials can be used as long as the semiconductor substrate can be processed in a general semiconductor manufacturing process. In addition, the insulating film is mainly expressed as a dielectric (SiO₂, SiNₓ, Al₂O₃), but a type, a composition, etc., of the film can be arbitrarily selected. Other than the above, an organic insulating film, for example, can also be used. Further, the material of the cap layer, the size and the number of the ashing holes provided at the cap layer, the places where the ashing holes should be arranged, etc., can arbitrarily be changed according to specifications.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor micro-analysis chip for detecting particles in a sample liquid comprising:
a semiconductor substrate;
a flow channel provided on a surface portion of the semiconductor substrate to allow the sample liquid to flow therein, at least an upper portion of the flow channel being covered by a cap layer;
a micropore provided at a part of the flow channel to allow the particles in the sample liquid to pass therethrough; and
a plurality of holes provided in the cap layer.

2. The chip of claim 1, wherein the flow channel is a groove-shaped tunnel-like flow channel formed by engraving the semiconductor substrate and providing an upper lid.

3. The chip of claim 1, further comprising channel portions which communicate with the flow channel at a plurality of places on sides of the flow channel, wherein the holes are formed in the cap layer on the channel portions, respectively.

4. The chip of claim 1, wherein the holes of the cap layer are ashing holes for performing ashing process.

5. The chip of claim 1, wherein the flow channel is a laminated tunnel-like flow channel formed by providing flow channel walls to form a hollow structure on the semiconductor substrate.

6. The chip of claim 1, further comprising a sample liquid inlet provided on an end side of the flow channel, and a sample liquid outlet provided on another end side of the flow channel.

7. The chip of claim 1, further comprising a plurality of columnar structures which are spread over the inside of the flow channel, and extending from a bottom surface to an upper surface of the flow channel.

8. A semiconductor micro-analysis chip for detecting particles in a sample liquid comprising:
a semiconductor substrate;
a first flow channel provided on a surface portion of the semiconductor substrate to allow the sample liquid to flow therein, at least an upper portion of the first flow channel being covered by a cap layer, a plurality of hole being formed in the cap layer;
a second flow channel, which is arranged differently from the first flow channel, on the surface portion of the semiconductor substrate to allow the sample liquid or an electrolyte to flow therein, at least an upper portion of the second flow channel being covered by a cap layer, a plurality of hole being formed in the cap layer;
a contact portion where a part of the first flow channel and a part of the second flow channel are adjacent to each other or cross one another with a partition arranged between the flow channels; and
a micropore which is provided in the partition, and allows the particles to pass therethrough.

9. The chip of claim 8, wherein the holes of the cap layers are ashing holes for performing ashing process.

10. The chip of claim 8, further comprising a first electrode exposed at least in part in the first flow channel, and a second electrode exposed at least in part in the second electrode.

11. The chip of claim 10, wherein the first electrode and the second electrode face each other with the micropore arranged therebetween.

12. The chip of claim 8, wherein the first flow channel is a groove-shaped tunnel-like flow channel formed by engraving the semiconductor substrate and providing an upper lid, and the second flow channel is a laminated tunnel-like flow channel formed by providing flow channel walls to form a hollow structure on the semiconductor substrate, and
at least a part of the partition in the contact portion is an upper surface of the first flow channel and a bottom surface of the second flow channel.

13. The chip of claim 8, wherein the first flow channel and the second flow channel are formed such that a difference between a height of a bottom surface of the first flow channel and a height of a bottom surface of the second flow channel is greater than or equal to a thickness of the cap layer covering the first flow channel,
an upper surface of the first flow channel and an upper surface of the second flow channel are formed at different heights, and
at least a part of the partition in the contact portion is the upper surface of the first flow channel and the bottom surface of the second flow channel.

14. The chip of claim 8, further comprising a particle size filter arranged at a downstream side of the micropore in one of the first flow channel and the second flow channel, the particle size filter allowing the sample liquid to pass therethrough and configured to collect the particles, wherein
the particles pass through the micropore from the flow channel on a side with the particle size filter to the flow channel on another side.

15. The chip of claim 8, further comprising:
a sample liquid outlet provided at an end side of the first flow channel;
a sample liquid or electrolyte outlet provided at an end side of the second flow channel;
a first absorber provided above the outlet of the first flow channel and configured to absorb the sample liquid; and
a second absorber provided above the outlet of the second flow channel and configured to absorb the sample liquid or electrolyte.

16. The chip of claim 8, further comprising channel portions which communicate with the first and second flow channels provided at a plurality of places on each side portion of the flow channels, wherein the holes are formed in the cap layers on the channel portions, respectively.

17. The chip of claim 8, further comprising a plurality of columnar structures inside at least one of the first flow channel and the second flow channel, the columnar structures extending from a bottom surface to an upper surface of the at least one of the flow channels.

18. The chip of claim 8, further comprising:
a package configured to contain the chip;
a first sample liquid inlet provided at an end side of the first flow channel;
a second sample liquid inlet provided at an end side of the second flow channel;
a first absorber provided above the first sample liquid inlet and configured to absorb the sample liquid;
a second absorber provided above the second sample liquid inlet and configured to absorb the sample liquid;
a sample liquid inlet port provided above the first and second absorbers of the package; and
a partition plate provided in the sample liquid inlet port, and configured to separate the sample liquid introduced into the sample liquid inlet port and to supply the separated sample liquid to the first and second absorbers.

19. A method of manufacturing a semiconductor micro-analysis chip comprising a flow channel which is provided on a surface portion of a semiconductor substrate to allow a sample liquid to flow therein, and a micropore for detecting particles in the sample liquid in a middle of the flow channel, the method comprising:
forming a sacrifice layer in a pattern of the flow channel for forming the flow channel;
forming a cap layer to cover the sacrifice layer;
forming ashing holes on an upper surface of the cap layer; and
supplying ashing gas to the sacrifice layer through the ashing holes, thereby removing the sacrifice layer.
